(19) United States
(12) Patent Application Publication
(10) Pub. No.: US 2026/0181558 A1
(43) Pub. Date: Jun. 25, 2026

(54) UE POWER ALLOCATION ACROSS UL CARRIERS WITH DYNAMIC WAVEFORM SWITCHING

(71) Applicant: Telefonaktiebolaget LM Ericsson (publ), Stockholm (SE)

(72) Inventors: Ling Su, Beijing (CN); Chunhui Zhang, Stockholm (SE)

(21) Appl. No.: 19/121,384

(22) PCT Filed: Nov. 1, 2023
(86) PCT No.: PCT/IB2023/061012

§ 371 Date: Apr. 15, 2025

(30) Foreign Application Priority Data
Nov. 4, 2022 (WO) PCT/CN2022/129953

(51) Int. Cl. H04W 52/14; H04W 72/20; H04W 72/56

(52) U.S. Cl. CPC H04W 52/146; H04W 72/20; H04W 72/56

(57) ABSTRACT

Systems and method provide for uplink carrier aggregation (UL CA) that is configured for a User Equipment (UE), and transmissions on multiple UL carriers by one power amplifier (PA). When a base station (e.g., a gNB) indicates the UE should switch its UL waveform from Cyclic-Prefix Orthogonal Frequency Division Multiplexing (CP-OFDM) to Discrete Fourier Transform Spread OFDM (DFT-S-OFDM) for Physical Uplink Shared Channel (PUSCH) transmission in one or more UL carriers, the base station expects that the UE transmit power on a particular carrier can be increased, the carrier for which a UL coverage issue (e.g., low signal strength, signal to noise ratio, interference, etc.) is found. UL waveform switching from CP-OFDM to DFT-S-OFDM can improve the lower bound of PCMAX, namely the total UE transmit power on UL carriers of intra-band CA.

### RELATED APPLICATIONS

This application claims the benefit of international patent application serial number PCT/CN2022/129953, filed Nov. 4, 2022, the disclosure of which is hereby incorporated herein by reference in its entirety.

### TECHNICAL FIELD

The present disclosure relates to an uplink carrier aggregation system that can improve power allocation by dynamic waveform switching.

### BACKGROUND

Power sharing mechanism is different between uplink carrier aggregation (UL CA) and New Radio Dual Connectivity (NR DC), which causes different Power Headroom (PH) reporting.

If a User Equipment (UE) is configured with UL CA, P_{CMAX,f,c}(i) is configured by the UE for active UL bandwidth part (BWP) b of carrier f of serving cell c, and PHtype 1, b, f, c is per combination of {b,f,c}. It is possible that there is a positive PH for a {b,f,c} combination, while it is negative for another {b,f,c} combination. This is an inefficient power sharing example, where the UE is power limited in one carrier, while there is still unused power in another carrier. This is because the PH reporting mechanism for UL CA doesn't take dynamic power sharing into account.

For NR DC with dynamic power sharing, there is no configured maximum power limit for a configured grant (CG), so there is no per-CG PH. The maximum transmission power on the Secondary Cell Group (SCG) is determined as:

$$min ( {\hat{P}}_{S C G} , {\hat{P}}_{Total}^{N R - D C} - {\hat{P}}_{MCG}^{actual} ) ,$$

if the UE determines transmission on the Master Cell Group (MCG) with a

$${\hat{P}}_{MCG}^{actual}$$

total power;

$${\hat{P}}_{Total}^{N R - D C} ,$$

if the UE does not determine any transmissions on the MCG.

### NR PUSCH Power Control and PH Report (38.213)

If a UE transmits a Physical Uplink Shared Channel (PUSCH) on active UL BWP b of carrier f of serving cell c using parameter set configuration with index j and PUSCH power control adjustment state with index l, the UE determines the PUSCH transmission power P_{PUSCH,b,f,c}(i, j, q_{d}, l) in PUSCH transmission occasion i as:

$${P}_{PUSCH , b , f , c} ( i , j , {q}_{d} , l ) = min \{ \begin{matrix}{P}_{CMAX , f , c} ( i ) , \\ \begin{matrix}{P}_{O \_ PUSCH , b , f , c} ( j ) + 10 {log}_{10} ( {2}^{μ} \cdot {M}_{RB , b , f , c}^{PUSCH} ( i ) ) + \\ {α}_{b , f , c} ( j ) \cdot {PL}_{b , f , c} ( {q}_{d} ) + {Δ}_{TF , b , f , c} ( i ) + {f}_{b , f , c} ( i , l )\end{matrix}\end{matrix} \} [ dBm ]$$

where,
P_{CMAX,f,c}(i) is the UE configured maximum output power defined in [8-1, TS 38.101-1], [8-2, TS 38.101-2] and [8-3, TS 38.101-3] for carrier f of serving cell c in PUSCH transmission occasion i.
P_{O_PUSCH,b,f,c}(j) is a parameter composed of the sum of a component P_{O_NOMINAL,PUSCH,f,c}(j) and a component P_{O_UE_PUSCH,b,f,c}(j) where j∈{0, 1, . . . , J−1}.

### Prioritizations for Transmission Power Reductions

For single cell operation with two uplink carriers or for operation with carrier aggregation, if a total UE transmit power for PUSCH or Physical Uplink Control Channel (PUCCH) or Physical Random Access Channel (PRACH) or Sounding Reference Signal (SRS) transmissions on serving cells in a frequency range in a respective transmission occasion i would exceed \hat{P}_{CMAX}(i), where \hat{P}_{CMAX}(i) is the linear value of P_{CMAX}(i) in transmission occasion i as defined in [8-1, TS 38.101-1] for Frequency Range 1 (FR1) and [8-2, TS 38.101-2] for FR2, the UE allocates power to PUSCH/PUCCH/PRACH/SRS transmissions according to the following priority order (in descending order) so that the total UE transmit power for transmissions on serving cells in the frequency range is smaller than or equal to \hat{P}_{CMAX}(i) for that frequency range in every symbol of transmission occasion i. For the purpose of power allocation in this clause, if a UE is provided UCI-MuxWithDifferentPriority and the UE multiplexes Hybrid ARQ Acknowledgement (HARQ-ACK) information in a PUSCH, a priority index of the PUSCH is the larger of (a) the priority index of the PUSCH according to clause 9 and (b) the larger priority index of the HARQ-ACK information. When determining a total transmit power for serving cells in a frequency range in a symbol of transmission occasion i, the UE does not include power for transmissions starting after the symbol of transmission occasion i. The total UE transmit power in a symbol of a slot is defined as the sum of the linear values of UE transmit powers for PUSCH, PUCCH, PRACH, and SRS in the symbol of the slot.

In case of same priority order and for operation with carrier aggregation, the UE prioritizes power allocation for transmissions on the primary cell of the MCG or the SCG over transmissions on a secondary cell. In case of same priority order and for operation with two UL carriers, the UE prioritizes power allocation for transmissions on the carrier where the UE is configured to transmit PUCCH. If PUCCH is not configured for any of the two UL carriers, the UE prioritizes power allocation for transmissions on the non-supplementary UL carrier.

### EN-DC

If a UE is configured with an MCG using Evolved Universal Mobile Telecommunications Service (UMTS) Terrestrial Radio Access (E-UTRA) radio access and with a SCG using NR radio access, the UE is configured a maximum power P_{LTE} for transmissions on the MCG by p-MaxEUTRA and a maximum power P_{NR} for transmissions in FR1 on the SCG by p-NR-FR1.

The UE determines a transmission power for the MCG as described in [13, TS 36.213] using P_{LTE} as the maximum transmission power. The UE determines transmission power for the SCG in FR1 as described in clauses 7.1 through 7.5 using P_{NR} as the maximum transmission power. The UE determines transmission power for the SCG in FR2 as described in clauses 7.1 through 7.5.

If a UE is configured with

$${\hat{P}}_{LTE} + {\hat{P}}_{N R} > {\hat{P}}_{Total}^{BN - DC} ,$$

where \hat{P}_{LTE} is the linear value of P_{LTE}, \hat{P}_{NR} is the linear value of P_{NR}, and

$${\hat{P}}_{Total}^{BN - DC}$$

is the linear value of a configured maximum transmission power for EN-DC operation as defined in [8-3, TS 38.101-3] for FR1, the UE determines a transmission power for the SCG as follows:
If the UE is configured with reference TDD configuration for E-UTRA (by tdm-PatternConfig or by tdm-PatternConfig2 in [13, TS 36.213]).
If the UE does not indicate a capability for dynamic power sharing between E-UTRA and NR for EN-DC, the UE does not transmit in a slot on the SCG in FR1 when a corresponding subframe on the MCG is an UL subframe in the reference TDD configuration.
If the UE indicates a capability for dynamic power sharing between E-UTRA and NR for EN-DC, and does not indicate a capability tdm-restrictionDualTX-FDD-endc-r16 in [18, TS 38.306], and is configured with tdm-PatternConfig2, the UE does not transmit on the SCG in FR1 when the UE has overlapped transmission on a subframe on the MCG.
If the UE indicates a capability for dynamic power sharing between E-UTRA and NR for EN-DC.
If UE transmission(s) in subframe i₁ of the MCG overlap in time with UE transmission(s) in slot i₂ of the SCG in FR1.
If

$${\hat{P}}_{MCG} ( {i}_{1} ) + {\hat{P}}_{S C G} ( {i}_{2} ) > {\hat{P}}_{Total}^{BN - DC}$$

in any portion of slot i₂ of the SCG.

The UE reduces transmission power in any portion of slot i₂ of the SCG so that

$${\hat{P}}_{M C G} ( {i}_{1} ) + {\hat{P}}_{S C G} ( {i}_{2} ) \leq {\hat{P}}_{Total}^{BN - DC}$$

in any portion of slot i₂, where \hat{P}_{MCG}(i₁) and \hat{P}_{SCG} (i₂) are the linear values of the total UE transmission powers in subframe i₁ of the MCG and in slot i₂ of the SCG in FR1, respectively. The UE is not required to transmit in any portion of slot i₂ of the SCG if \hat{P}_{SCG} (i₂) would need to be reduced by more than the value provided by XSCALE in order for

$${\hat{P}}_{M C G} ( {i}_{1} ) + {\hat{P}}_{S C G} ( {i}_{2} ) \leq {\hat{P}}_{Total}^{EN - DC}$$

in any portion of slot i₂ of the SCG. The UE is required to transmit in slot i₂ of the SCG if \hat{P}_{SCG}(i₂) would not need to be reduced by more than the value provided by XSCALE in order for

$${\hat{P}}_{M C G} ( {i}_{1} ) + {\hat{P}}_{S C G} ( {i}_{2} ) \leq {\hat{P}}_{Total}^{EN - DC}$$

in all portions of slot i₂.

### NR DC

If a UE is provided dynamic for nrdc-PCmode-FR1 or for nrdc-PCmode-FR2, and indicates a capability to support dynamic power sharing for intra-FR NR DC, the UE determines a maximum transmission power on the SCG at a first symbol of a transmission occasion on the SCG by determining transmissions on the MCG that:
are scheduled by Downlink Control Channel (DCI) formats in Physical Downlink Control Channel PDCCH receptions with a last symbol that is earlier by at least T_{offset} from the first symbol of the transmission occasion on the SCG, or are configured by higher layers, and
overlap with the transmission occasion on the SCG.

The maximum transmission power on the SCG is determined as:

$$min ( {\hat{P}}_{S C G} , {\hat{P}}_{Total}^{N R - D C} - {\hat{P}}_{MCG}^{actual} ) ,$$

if the UE determines transmissions on the MCG with a

$${\hat{P}}_{MCG}^{actual}$$

total power

$${\hat{P}}_{Total}^{N R - D P} ,$$

if the UE does not determine any transmissions on the MCG
Where

$${\hat{P}}_{MCG}^{actual}$$

is the total power for the transmissions on the MCG that overlap with the transmission occasion on the SCG where

$${\hat{P}}_{MCG}^{actual}$$

transmissions configured by higher layers and on transmissions scheduled by DCI formats in PDCCH receptions with a last symbol that is at least T_{offset} before the first symbol of the transmission occasion on the SCG.

### Power Headroom Report

If a UE is configured with a SCG and if phr-ModeOtherCG for a CG indicates ‘virtual’ then, for power headroom reports transmitted on the CG, the UE computes PH assuming that the UE does not transmit PUSCH/PUCCH on any serving cell of the other CG. For NR-DC when both the MCG and the SCG operate either in FR1 or in FR2 and for a power headroom report transmitted on the MCG or the SCG, the UE computes PH assuming that the UE does not transmit PUSCH/PUCCH on any serving cell of the SCG or the MCG, respectively.

If a UE determines that a Type 1 power headroom report for an activated serving cell is based on an actual PUSCH transmission then, for PUSCH transmission occasion i on active UL BWP b of carrier f of serving cell c, the UE computes the Type 1 power headroom report as:

$$P {H}_{t ype 1 , b , f , c} ( i , j , {q}_{d} , l ) = {P}_{CMAX , f , c} ( i ) - \{ {P}_{O \_ PUSCH , b , f , c} ( j ) + 10 {log}_{10} ( {2}^{μ} \cdot {M}_{RB , b , f , c}^{PUSCH} ( i ) ) + {α}_{b , f , c} ( j ) \cdot {PL}_{b , f , c} ( {q}_{d} ) + {Δ}_{TF , b , f , c} ( i ) + {f}_{b , f , c} ( i , l ) \} [ dB ]$$

$$where {P}_{CMAX , f , c} ( i ) , {P}_{O \_ PUSCH , b , f , c} ( j ) ,$$

$${M}_{RB , b , f , c}^{PUSCH} ( i ) , {α}_{b , f , c} ( j ) , P {L}_{b , f , c} ( {q}_{d} ) , {Δ}_{TF , b , f , c} ( i ) and {f}_{b , f , c} ( i , l )$$

$$are defined in clause 7.11 .$$

If a UE is configured with multiple cells for PUSCH transmissions, where a SCS configuration μ₁ on active UL BWP b₁ of carrier f₁ of serving cell c₁ is smaller than a SCS configuration μ₂ on active UL BWP b₂ of carrier f₂ of serving cell c₂, and if the UE provides a Type 1 power headroom report in a PUSCH transmission in a slot on active UL BWP b₁ that overlaps with multiple slots on active UL BWP b₂, the UE provides a Type 1 power headroom report for the first PUSCH, if any, on the first slot of the multiple slots on active UL BWP b₂ that fully overlaps with the slot on active UL BWP b₁.

If a UE is configured with multiple cells for PUSCH transmissions, where a same SCS configuration on active UL BWP b₁ of carrier f₁ of serving cell c₁ and active UL BWP b₂ of carrier f₂ of serving cell c₂, and if the UE provides a Type 1 power headroom report in a PUSCH transmission in a slot on active UL BWP b₁, the UE provides a Type 1 power headroom report for the first PUSCH, if any, on the slot on active UL BWP b₂ that overlaps with the slot on active UL BWP b₁.

If a UE is configured with multiple cells for PUSCH transmissions and provides a Type 1 power headroom report in a PUSCH transmission with PUSCH repetition Type B having a nominal repetition that spans multiple slots on active UL BWP b₁ and overlaps with one or more slots on active UL BWP b₂, the UE provides a Type 1 power headroom report for the first PUSCH, if any, on the first slot of the one or more slots on active UL BWP b₂ that overlaps with the multiple slots of the nominal repetition on active UL BWP b₁.

For a UE configured with EN-DC/NE-DC and capable of dynamic power sharing, if E-UTRA Dual Connectivity PHR [14, TS 36.321] is triggered, the UE provides power headroom of the first PUSCH, if any, on the determined NR slot as described in clause 7.7.

If a UE is configured with multiple cells for PUSCH transmissions, the UE does not consider for computation of a Type 1 power headroom report in a first PUSCH transmission that includes an initial transmission of transport block on active UL BWP b₁ of carrier f₁ of serving cell c₁, a second PUSCH transmission on active UL BWP b₂ of carrier f₂ of serving cell c₂ that overlaps with the first PUSCH transmission if:
the second PUSCH transmission is scheduled by a DCI format in a PDCCH received in a second PDCCH monitoring occasion, and
the second PDCCH monitoring occasion is after a first PDCCH monitoring occasion where the UE detects the earliest DCI format scheduling an initial transmission of a transport block after a power headroom report was triggered
   or, if:
the second PUSCH transmission is after the first uplink symbol of the first PUSCH transmission minus T′_{proc,2}=T_{proc,2} where T_{proc,2} is determined according to [6, TS 38.214] assuming d_{2,1}=1, d_{2,2}=0, and with μ_{DL} corresponding to the subcarrier spacing of the active downlink BWP of the scheduling cell for a configured grant if the first PUSCH transmission is on a configured grant after a power headroom report was triggered.

### UE Maximum Output Power Reduction

TABLE 6.2.2-1
Maximum power reduction (MPR) for power class 3

| | | MPR (dB) | | |
|---|---|---|---|---|
| | | Edge RB | Outer RB | Inner RB |
| Modulation | | allocations | allocations | allocations |
| DFT-s- | Pi/2 BPSK | ≤3.5¹ | ≤1.2¹ | ≤0.2¹ |
| OFDM | | ≤0.5² | ≤0.5² | 0² |
| | Pi/2 BPSK | ≤0.5² | 0² | 0² |
| | w Pi/2 | | | |
| | BPSK DMRS | | | |

| | QPSK | ≤1 | 0 |
|---|---|---|---|
| | 16 QAM | ≤2 | ≤1 |
| | 64 QAM | ≤2.5 | |
| | 256 QAM | ≤4.5 | |
| CP- | QPSK | ≤3 | ≤1.5 |
| OFDM | 16 QAM | ≤3 | ≤2 |

| | |
|---|---|
| 64 QAM | ≤3.5 |
| 256 QAM | ≤6.5 |

NOTE 1:
Applicable for UE operating in TDD mode with Pi/2 BPSK modulation and UE indicates support for UE capability powerBoosting-pi2BPSK and if the IE powerBoostPi2BPSK is set to 1 and 40% or less slots in radio frame are used for UL transmission for bands n40, n41, n77, n78 and n79. The reference power of 0 dB MPR is 26 dBm.
NOTE 2:
Applicable for UE operating in FDD mode, or in TDD mode in bands other than n40, n41, n77, n78 and n79 with Pi/2 BPSK modulation and if the IE powerBoostPi2BPSK is set to 0 and if more than 40% of slots in radio frame are used for UL transmission for bands n40, n41, n77, n78 and n79.

### Configured Transmitted Power

The UE is allowed to set its configured maximum output power P_{CMAX,f,c} for carrier f of serving cell c in each slot. The configured maximum output power P_{CMAX,f,c} is set within the following bounds:

$${P}_{CMAX \_ L , f , c} \underline{<} {P}_{CMAX , f , c} \leq {P}_{CMAX \_ H , f , c} with$$

$${P}_{CMAX \_ L , f , c} = MIN \{ {P}_{EMAX , c} - Δ {T}_{C , c} , ( {P}_{PowerClass} - Δ {P}_{PowerClass} ) - MAX ( \text{} MAX ( \text{} {MPR}_{c} + Δ MP {R}_{c} , A - MP {R}_{c} ) + Δ {T}_{IB , c} + Δ {T}_{C , c} + Δ {T}_{R x S R S} , P - MP {R}_{c} ) \}$$

$${P}_{CMAX \_ H , f , c} = MIN \{ {P}_{EMAX , c} , {P}_{PowerClass} - Δ {P}_{PowerClass} \}$$

$${P}_{CMAX \_ L} = MIN \{ 10 {log}_{10} \sum MIN [ {p}_{EMAX , c} / ( Δ {t}_{C , c} ) , {p}_{PowerClass . c} / ( MAX ( m p {r}_{c} \cdot Δ {mpr}_{c} , a - {mpr}_{c} ) \cdot Δ {t}_{C , c} \cdot Δ {t}_{IB , c} \cdot Δ {t}_{RxSRS , c} ) , {p}_{PowerClass , c} / {pmpr}_{c} ] , {P}_{EMAX , CA} , {P}_{PowerClass , CA} - Δ {P}_{PowerClass , CA} \}$$

$${P}_{CMAX \_ H} = MIN \{ 10 {log}_{10} \sum {p}_{EMAX , c} , {P}_{EMAX , CA} , {P}_{PowerClass , CA} - Δ {P}_{PowerClass , CA} \}$$

where:
P_{EMAX,c} is the value given by either the p-Max IE or the field additionalPmax of the NR-NS-PmaxList IE, whichever is applicable according to TS 38.331 [7];
   P_{PowerClass} is the maximum UE power specified in Table 6.2.1-1 without taking into account the tolerance specified in the Table 6.2.1-1.

### UE Maximum Output Power for CA

For intra-band contiguous carrier aggregation the maximum power requirement shall apply to the total transmitted power over all component carriers (per UE).

For intra-band non-contiguous carrier aggregation, the maximum power requirement shall apply to the total transmitted power over all component carriers (per UE).

### UE Maximum Output Power for Inter-Band CA

For inter-band uplink carrier aggregation with uplink assigned to two NR bands, UE maximum output power shall be measured over all component carriers from different bands. If each band has separate antenna connectors, maximum output power is defined as the sum of maximum output power from each UE antenna connector.

UE Maximum Output Power Reduction for Intra-Band Contiguous CA

UE Maximum Output Power Reduction for Inter-Band CA

For inter-band carrier aggregation with uplink assigned to two NR bands, the requirements apply for each uplink component carrier.

Configured transmitted power for Intra-band contiguous CA.

For uplink carrier aggregation the UE is allowed to set its configured maximum output power PCMAX,c for serving cell c and its total configured maximum output power PCMAX.

The configured maximum output power PCMAX,c on serving cell c shall be set as specified in clause 6.2.4, but with MPRc=MPR and A-MPRc=A-MPR with MPR and A-MPR as determined by subclause 6.2A.2 and 6.2A.3, respectively. For PH reporting the following exception applies: if the UE is configured with multiple uplink serving cells, the power PCMAX,c used for the purpose of PH reporting on first serving cell c=c1 does not consider for computation of the PH report transmissions on a second serving cell c2 as exempted in subclause 7.7.1 in [8]. There is one power management term for the UE, denoted P-MPR, and P-MPR c=P-MPR.

The total configured maximum output power P_{CMAX} shall be set within the following bounds:

$${P}_{CMAX \_ L} \leq {P}_{CMAX} \leq {P}_{CMAX \_ H}$$

For uplink intra-band contiguous carrier aggregation when same slot pattern is used in all aggregated serving cells,

$${P}_{CMAX \_ L} = MIN \{ 10 {log}_{10} \sum {p}_{EMAX , c} - {DT}_{C} , {P}_{EMAX , CA} , ( {P}_{P o w erClass , CA} - Δ {P}_{PowerClass , CA} ) - MAX ( MAX ( MPR , A - MPR ) + Δ {T}_{IB , c} + {DT}_{C} + {DT}_{R xSRS} , P - {MPR}_{c} ) \}$$

$${P}_{CMAX \_ H} = MIN \{ 10 {log}_{10} \sum {p}_{EMAX , c} , {P}_{E M A X , C A} , {P}_{P o w erClass , CA} - Δ {P}_{PowerClass , CA} \}$$

where:
P_{EMAX,c} is the linear value of P_{EMAX,c} which is given by IE P-Max for serving cell c in [7];
P_{PowerClass,CA} is the maximum UE power specified in Table 6.2A.1.1-1 without taking into account the tolerance;
MPR and A-MPR are specified in clause 6.2A.2 and 6.2A.3, respectively.

The configured maximum output power PCMAX,c on serving cell c shall be set as specified in subclause 6.2.4, but with MPRc=MPR and A-MPRc=A-MPR with MPR and A-MPR as determined by subclause 6.2A.2 and 6.2A.3, respectively. For PH reporting the following exception applies: if the UE is configured with multiple uplink serving cells, the power PCMAX,c used for the purpose of PH reporting on first serving cell c=c1 does not consider for computation of the PH report transmissions on a second serving cell c2 as exempted. There is one power management term for the UE, denoted P-MPR, and P-MPR c=P-MPR.

For uplink inter-band carrier aggregation, MPR_{c} and A-MPR_{c} apply per serving cell c and are specified in clause 6.2.2 and clause 6.2.3, respectively. P-MPR c accounts for power management for serving cell c. P_{CMAX,c} is calculated under the assumption that the transmit power is increased independently on all component carriers.

The total configured maximum output power PCMAX shall be set within the following bounds:

$${P}_{CMAX \_ L} \leq {P}_{CMAX} \leq {P}_{CMAX \_ H}$$

For uplink inter-band carrier aggregation with one serving cell c per operating band when same slot symbol pattern is used in all aggregated serving cells:

$${P}_{CMAX \_ L} = MIN \{ 10 {log}_{10} \sum MIN [ {p}_{EMAX , c} / {Dt}_{C , c} ) , {p}_{PowerClass . c} / ( MAX ( {mpr}_{c} \cdot Δ {mpr}_{c} , a - {mpr}_{c} ) \cdot {Dt}_{C , c} \cdot {Dt}_{IB , c} \cdot {Dt}_{RxSRS} ) , {p}_{PowerClass , c} / {pmpr}_{c} ] , {P}_{EMAX , CA} , {P}_{PowerClass , CA} - Δ {P}_{PowerClass , C A} \}$$

$${P}_{CMAX \_ H} = MIN \{ 10 {log}_{10} \sum {p}_{EMAX , c} , {P}_{EMAX , CA} , {P}_{PowerClass , CA} - Δ {P}_{PowerClass , C A} \}$$

Unless otherwise stated, the transmitter characteristics are specified over the air (OTA) with a single or multiple transmit chains.

### UE Maximum Output Power for Power Class 3

The following requirements define the maximum output power radiated by the UE for any transmission bandwidth within the channel bandwidth for non-CA configuration, unless otherwise stated. The period of measurement shall be at least one sub frame (1 ms). The minimum output power values for EIRP are found in Table 6.2.1.3-1. The requirement is verified with the test metric of total component of EIRP (Link=TX beam peak direction, Meas=Link angle). The requirement for the UE which supports a single FR2 band is specified in Table 6.2.1.3-1. The requirement for the UE which supports multiple FR2 bands is specified in both Table 6.2.1.3-1 and Table 6.2.1.3-4.

TABLE 6.2.1.3-1
UE minimum peak EIRP for power class 3

| Operating band | Min peak EIRP (dBm) |
|---|---|
| n257 | 22.4 |
| n258 | 22.4 |
| n259 | 18.7 |
| n260 | 20.6 |
| n261 | 22.4 |
| n262 | 16.0 |
| n263 | 7.6 |

NOTE 1:
Minimum peak EIRP is defined as the lower limit without tolerance
NOTE 2:
Void

The maximum output power values for TRP and EIRP are found on the Table 6.2.1.3-2. The max allowed EIRP is derived from regulatory requirements [8]. The requirements are verified with the test metrics of TRP (Link=TX beam peak direction, Meas=TRP grid) in beam locked mode and the total component of EIRP (Link=TX beam peak direction, Meas=Link angle.

TABLE 6.2.1.3-2
UE maximum output power limits for power class 3

| Operating | Max TRP | Max EIRP | Max EIRP | |
|---|---|---|---|---|
| band | (dBm) | (dBm) | (dBm/MHz) | Notes |
| n257 | 23 | 43 | | |
| n258 | 23 | 43 | | |
| n259 | 23 | 43 | | |
| n260 | 23 | 43 | | |
| n261 | 23 | 43 | | |
| n262 | 23 | 43 | | |
| n263 | FFS | FFS | | [Default for |
| | | | | NS_200] |
| | 27 | 40 (NOTE1) | 23 | Applies when |
| | | | | “NS_204” is |
| | | | | indicated in the |
| | | | | cell |

(NOTE1):
it is max average EIRP

The minimum EIRP at the 50th percentile of the distribution of radiated power measured over the full sphere around the UE is defined as the spherical coverage requirement and is found in Table 6.2.1.3-3 below. The requirement is verified with the test metric of the total component of EIRP (Link=Beam peak search grids, Meas=Link angle). The requirement for the UE which supports a single FR2 band is specified in Table 6.2.1.3-3. The requirement for the UE which supports multiple FR2 bands is specified in both Table 6.2.1.3-3 and Table 6.2.1.3-4.

TABLE 6.2.1.3-3
UE spherical coverage for power class 3

| | Min EIRP at 50%-tile CDF |
|---|---|
| Operating band | (dBm) |
| n257 | 11.5 |
| n258 | 11.5 |
| n259 | 5.8 |
| n260 | 8 |
| n261 | 11.5 |
| n262 | 2.9 |
| n263 | 2.3 |

NOTE 1:
Minimum EIRP at 50%-tile CDF is defined as the lower limit without tolerance
NOTE 2:
Void
NOTE 3:
The requirements in this table are verified only under normal temperature conditions as defined in Annex E.2.1.

### 6.2.2.3 UE Maximum Output Power Reduction for Power Class 3

For power class 3, MPR for contiguous allocations is defined as:

$$MPR = max ( {MPR}_{WT} , {MPR}_{n a r r o w} )$$

For transmission bandwidth configuration less than or equal to 200 MHz, and 0≤RBₛₜₐᵣₜ<Ceil(⅓ N_{RB}) or Ceil((⅔N_{RB})−L_{CRB})<RBₛₜₐᵣₜ≤N_{RB}−L_{CRB}:
MPR_{narrow}=2.5 dB, when BW_{alloc,RB} is less than or equal to 1.44 MHz,
MPR_{narrow}=2.0 dB, when 1.44 MHz<BW_{alloc,RB}<=4.32 MHz, otherwise MPR_{narrow}=0 dB.
MPR_{WT} is the maximum power reduction due to modulation orders, transmission bandwidth configurations listed in Table 5.3.2-1, and waveform types. MPR_{WT} is defined for FR2-1 in Table 6.2.2.3-1.

TABLE 6.2.2.3-1
MPR_{WT} for power class 3, BWchannel ≤ 200 MHz, FR2-1

| | | MPR_{WT}, BW_{channel} ≤ 200 MHz | |
|---|---|---|---|
| | | Inner RB allocations, | |
| Modulation | | Region 1 | Edge RB allocations |
| DFT-s-OFDM | Pi/2 BPSK | 0.0 | ≤2.0 |
| | QPSK | 0.0 | ≤2.0 |
| | 16 QAM | ≤3.0 | ≤3.5 |
| | 64 QAM | ≤5.0 | ≤5.5 |
| CP-OFDM | QPSK | ≤3.5 | ≤4.0 |
| | 16 QAM | ≤5.0 | ≤5.0 |
| | 64 QAM | ≤7.5 | ≤7.5 |

For transmission bandwidth configuration equal to 400 MHz:

MPR_{narrow}=2.5 dB, when BW_{alloc,RB} is less than or equal to 1.44 MHz, and 0≤RBₛₜₐᵣₜ<Ceil(⅓ N_{RB}) or Ceil(⅔N_{RB})≤RBₛₜₐᵣₜ≤N_{RB}−L_{CRB}, where BW_{alloc,RB} is the bandwidth of the RB allocation size.

MPRWT is the maximum power reduction due to modulation orders, transmission bandwidth configurations listed in Table 5.3.2-1, and waveform types. MPRWT is defined for FR2-1 in Table 6.2.2.3-2.

TABLE 6.2.2.3-2
MPR_{WT} for power class 3, BW_{channel} = 400 MHz, FR2-1

| | | MPR_{WT}, BW_{channel} = 400 MHz | |
|---|---|---|---|
| | | Inner RB allocations, | |
| Modulation | | Region 1 | Edge RB allocations |
| DFT-s-OFDM | Pi/2 BPSK | 0.0 | ≤3.0 |
| | QPSK | 0.0 | ≤3.0 |
| | 16 QAM | ≤4.5 | ≤4.5 |
| | 64 QAM | ≤6.5 | ≤6.5 |
| CP-OFDM | QPSK | ≤5.0 | ≤5.0 |
| | 16 QAM | ≤6.5 | ≤6.5 |
| | 64 QAM | ≤9.0 | ≤9.0 |

### 6.2.4 Configured Transmitted Power

The UE can configure its maximum output power. The configured UE maximum output power P_{CMAX,f,c} for carrier f of a serving cell c is defined as that available to the reference point of a given transmitter branch that corresponds to the reference point of the higher-layer filtered RSRP measurement as specified in TS 38.215 [11].

The configured UE maximum output power P_{CMAX,f,c} for carrier f of a serving cell c shall be set such that the corresponding measured peak EIRP P_{UMAX,f,c} is within the following bounds:

$${P}_{Powerclass} + Δ {P}_{I B E} - MAX ( MAX ( M P {R}_{f , c} , A - {MPR}_{f , c} , ) + Δ {MB}_{P , n} , P - MP {R}_{f , c} ) - MAX \{ T ( MAX ( M P {R}_{f , c} , A - {MPR}_{f , c} , ) ) ,$$

$$T ( P - MP {R}_{f , c} ) \} \underline{<} {P}_{UMAX , f , c} \underline{<} {EIRP}_{max}$$

while the corresponding measured total radiated power P_{TMAX,f,c} is bounded by

$${P}_{TMAX , f , c} \leq {TRP}_{max}$$

With P_{Powerclass} the UE minimum peak EIRP as specified in sub-clause 6.2.1, EIRPₘₐₓ the applicable maximum EIRP as specified in sub-clause 6.2.1, MPR_{f,c} as specified in sub-clause 6.2.2, A-MPR_{f,c} as specified in sub-clause 6.2.3, ΔMB_{P,n} the peak EIRP relaxation as specified in clause 6.2.1 and TRPₘₐₓ the maximum TRP for the UE power class as specified in sub-clause 6.2.1. ΔP_{IBE} is 1.0 dB if UE declares support for mpr-PowerBoost-FR2-r16, UL transmission is QPSK, MPR_{f,c}=0 and when NS_200 applies and the network configures the UE to operate with mpr-PowerBoost-FR2-r16otherwise ΔP_{IBE} is 0.0 dB. The requirement is verified in beam peak direction.

### 6.2A Transmitter Power for CA

### 6.2A.1 UE Maximum Output Power for CA

For uplink intra-band contiguous and non-contiguous carrier aggregation for any CA bandwidth class, the maximum output power is specified in clause 6.2.1.

For inter-band uplink CA with two NR bands with each UL band configured with a single CC, the maximum power requirements are applicable per band, with both carriers active with non-zero power UL RB allocation. The maximum output power values for TRP and EIRP are applicable per carrier and are specified in tables 6.2.1.x-2. The minimum peak values for EIRP are defined in Tables 6.2.1.x-1 and further relaxed by ΔT_{IB,P,n} specified in Table 6.2A.1-x. The peak EIRP requirements are verified with the test metric of EIRP (Link=TX beam peak direction, Meas=Link angle).

### 6.2A.2.1 General

The UE is defined to be configured for CA operation when it has at least one of UL or DL configured for CA. In CA operation, the UE may reduce its maximum output power due to higher order modulations and transmit bandwidth configurations. This Maximum Power Reduction (MPR) is defined in clauses below. The allowed MPR for SRS, PUCCH formats 0, 1, 3 and 4, shall be as specified for QPSK modulated Discrete Fourier Transform Spread OFDM (DFT-S-OFDM) of equivalent RB allocation. The allowed MPR for PUCCH format 2, shall be as specified for QPSK modulated Cyclic-Prefix Orthogonal Frequency Division Multiplexing (CP-OFDM) of equivalent RB allocation.

When the maximum output power of a UE is modified by MPR, the power limits specified in clause 6.2A.4 apply. The requirements in the following clauses are applicable to the following CA configurations:
intra-band contiguous uplink CA, with the aggregated channel bandwidth no greater than 800 MHz.
intra-band non-contiguous uplink CA with UL frequency separation no greater than 1400 MHz, and no more than 3 sub-blocks. A sub-block may consist of single CC or multiple contiguous CCs.
inter-band uplink CA with two NR bands, and each UL band is configured with a single CC.
In case the CA configuration consists of a single UL CC, MPR for contiguous UL CA applies and where necessary, BW_{channel} shall be used as BW_{channel_CA}.

### 6.2A.2.4.1 Maximum Output Power Reduction for Power Class 3 Intra-Band Contiguous CA

In case of a contiguous RB, DFT-s-BPSK or DFT-s-QPSK UL allocation in a single CC of a CA configuration with contiguous CCs, and whose cumulative aggregated BW≤400 MHz, MPR_{C_CA} shall be derived instead as MAX(MPR₁, MPR₂), where:
MPR₁ shall be determined from Table 6.2.2.3-1 if CABW £ 200 MHz, from Table 6.2.2.3-2 if CABW>200 MHz.
MPR₂ shall be determined from Table 6.2.2.3-1 if UL BW_{channel_CA} £ 200 MHz, from Table 6.2.2.3-2 if UL BW_{channel_CA}>200 MHz.
   and assume all UL CCs use the same SCS for the purpose of determination of inner and outer RB allocations in Table 6.2.2.3-1 and Table 6.2.2.3-2:
N_{RB} shall be chosen as the sum of N_{RB} of all constituent UL CCs in the CA configuration.
LCRB shall be chosen as BWalloc,RB
RBstart shall be derived as: RBstart_allocatedCC+NRB_unallocatedCC_low
RBstart_allocatedCC is the index of the first allocated RB in the CC with allocation
NRB_unallocatedCC_low is the sum of NRB in all UL CCs lower in frequency compared to the CC with allocation.
   When different waveform types exist across CCs, the requirement is set by the waveform type used in the configuration with the highest contiguous MPR.
   For intra-band contiguous UL CA with non-contiguous RB allocations, the following rule for MPR applies:

$$MPR = max ( {MPR}_{C \_ CA} , - 10 * A + 7. )$$

### Where:

$$A = {N}_{RB \_ alloc} / {N}_{RB \_ agg \_ C} .$$

N_{RB_alloc} is the total number of allocated UL RBs
   N_{RB_agg_c} is the number of the aggregated RBs within the fully allocated cumulative aggregated channel bandwidth assuming lowest SCS among all configured CCs.

### 6.2A.4 Configured Transmitted Power for CA

### 6.2A.4.1 Configured Transmitted Power for Intra-Band UL CA

A UE configured with carrier aggregation can configure its maximum output power for each uplink activated serving cell c and its total configured maximum output power P_{CMAX}. The definition of the configured UE maximum output power P_{CMAX,f,c} for each carrier f of a serving cell cis used for power headroom reporting for carrier f of serving cell c only and is in accordance with that specified in clause 6.2.4 with parameters MPR, A-MPR and P-MPR replaced with those specified in subclause 6.2A.2, 6.2A.3 and 6.2.4, respectively.

The UE maximum configured power P_{CMAX} in a transmission occasion is determined by the UL grants for carriers f of all serving cells c with non-zero granted power in the respective reference point.

For uplink intra-band contiguous carrier aggregation, MPR is specified in clause 6.2A.2. P_{CMAX} is calculated under the assumption that power spectral density for each RB in each component carrier is same.

The configured UE maximum output power P_{CMAX} shall be set such that the corresponding measured total peak EIRP P_{UMAX} is within the following bounds:

$${P}_{Powerclass} - MAX ( MAX ( MPR , A - MPR ) + {ΔMB}_{P , n} , P - MPR ) - MAX \{ T ( MAX ( MPR , A - MPR ) ) , T ( P - MPR ) \} \leq {P}_{UMAX} \leq {EIRP}_{max}$$

with P_{Powerclass} the peak EIRP as specified in sub-clause 6.2A.1, EIRPₘₐₓ the applicable maximum EIRP as specified in sub-clause 6.2A.1, MPR as specified in sub-clause 6.2A.2, A-MPR as specified in sub-clause 6.2A.3, ΔMB_{P,n} the peak EIRP relaxation as specified in clause 6.2.1, P-MPR the power management term for the UE as described in 6.2.4. The measured configured power P_{UMAX} for carrier aggregation is defined as

$${P}_{UMAX} = 10 {log}_{10} {\sum }_{c , f ( c )} {p}_{UMAX , f , c}$$

where p_{UMAX,f,c} is the linear value of the measured power P_{UMAX,f,c} for carrier f=f(c) of serving cell c. The measured total radiated power P_{TMAX} for carrier aggregation is defined as

$${P}_{TMAX} = 10 {log}_{10} {\sum }_{c , f ( c )} {p}_{UMAX , f , c}$$

where p_{TMAX,f,c} is the linear value of the measured total radiated power P_{TMAX,f,c} for carrier f=f(c) of serving cell c. The total radiated power P_{TMAX} is bounded by:

$${P}_{TMAX} \leq {TRP}_{max}$$

where TRPₘₐₓ the maximum TRP for the UE power class as specified in sub-clause 6.2A.1.

### 6.2A.4.2 Configured Transmitted Power for Inter-Band UL CA

A UE can configure its maximum output power for each uplink band when it is configured for inter-band UL carrier aggregation with two NR bands each with a single UL CC. For each uplink band n, the configured UE maximum output power P_{CMAX,f,c,n} for carrier f of a serving cell cis defined as that available to the reference point of a given transmitter branch that corresponds to the reference point of the higher-layer filtered RSRP measurement as specified in TS 38.215 [11].

The configured UE maximum output power P_{CMAX,f,c,n} for carrier f of a serving cell c in band n shall be set such that the corresponding measured peak EIRP P_{UMAX,f,c,n} is within the following bounds:

$${P}_{Powerclass} + {DP}_{IBE} - MAX ( MAX ( {MPR}_{f , c , n} , A - {MPR}_{f , c , n} ) + Δ {TIB}_{P , n} , P - {MPR}_{f , c , n} ) - Max \{ T ( MAX ( {MPR}_{f , c , n} , A - {MPR}_{f , c , n} , ) ) , T ( P - {MPR}_{f , c , n} ) \} \leq {P}_{UMAX , f , c , n} \leq {EIRP}_{max , n}$$

while the corresponding measured total radiated power in uplink band n, P_{TMAX,f,c,n}, is bounded by

$${P}_{TMAX , f , c , n} \leq {TRP}_{max , n}$$

with P_{Powerclass} the UE power class as specified in sub-clause 6.2.1, EIRP_{max,n} the applicable maximum EIRP as specified in sub-clause 6.2A.1 for uplink band n and TRP_{max,n} the applicable maximum TRP as specified in sub-clause 6.2A.1 for uplink band n. MPR_{f,c,n} as specified in sub-clause 6.2A.2, A-MPR_{f,c,n} as specified in sub-clause 6.2A.3, ΔTIB_{P,n} the peak EIRP relaxation as specified in clause 6.2A.1 and TRPₘₐₓ the maximum TRP for the UE power class as specified in sub-clause 6.2.1. The requirement is verified in beam peak direction.
ΔP_{IBE}, mpr-PowerBoost-FR2-r16 and maxUplinkDutyCycle-FR2 are described in clause 6.2.4.
P-MPR_{f,c,n} is the power management maximum output power reduction P-MPR_{f,c} in band n. P-MPR_{f,c} is defined in clause 6.2.4.
The tolerance T (AP) for applicable values of AP (values in dB) in each band is specified in Table 6.2.4-1.

### 2.1.4 Study of UL CA in Terms of MPR and Configured Transmitted Power

### 2.1.4.1 UL CA in FR1

Three types of UL CA are supported in FR1, namely, intra-band contiguous UL CA, intra-band non-contiguous UL CA and inter-band UL CA. The combination of multiple types are also supported for UL CA with three carriers, since it follows the corresponding requirement of the three basic types, the present disclosure focuses on the three types of UL CA.

### Intra-Band Contiguous UL CA

For Intra-band contiguous CA, the lower end of P_{CMAX} and the lower end of P_{CMAX,f,c} are denoted by P_{CMAX_L} and P_{CMAX_L,f,c} and obtained with the following equations. Though both are the minimum value of several factors, the highlighted factors in both equations are possibly the most limiting one and the same. In this sense, P_{CMAX_L} equals P_{CMAX_L,f,c}.

$${P}_{CMAX \_ L} = MIN \{ 10 {log}_{10} \sum {p}_{EMAX , c} - {DT}_{C} , {P}_{EMAX , CA} , ( {P}_{PowerClass , CA} - Δ {P}_{PowerClass , CA} ) - MAX ( MAX ( MPR , A - MPR ) + Δ {T}_{IB , c} + {DT}_{C} + {DT}_{RXSRS} , P - {MPR}_{c} ) \} ( CA )$$

$${P}_{CMAX \_ L , f , c} = MIN \{ {P}_{EMAX , c} - Δ {T}_{C , c} , ( {P}_{PowerClass} - Δ {P}_{PowerClass} ) - MAX ( MAX ( {MPR}_{c} + Δ {MPR}_{c} , A - {MPR}_{c} ) + Δ {T}_{IB , c} + Δ {T}_{C , c} + Δ {T}_{RXSRS} , P - {MPR}_{c} ) \} ( CA )$$

According to Table 6.2.2-1 and Table 6.2A.2.1-1 in 38.101-1, the present disclosure takes an example of power class 3, inner RB allocations and QPSK. The present disclosure only focuses on P_{PowerClass}, MPR, P_{CMAX,f,c} and P_{CMAX}. 0 dB and 1.5 dB MPR are defined for DFT-S-OFDM and CP-OFDM for non-CA configuration. With Intra-band contiguous CA, MPR for bandwidth class B (dB), MPR for the two UL waveforms are 1 and 2 dB respectively, when the signaling is absent for dualPA-architecture IE.

In case the modulation format or waveform is different on different component carriers then the MPR is determined by the rules applied to higher order of those modulations, or CP-OFDM waveform.

According to the rule, even if the UL coverage issue may be in one of the UL carriers, the gNB may switch the waveforms of all UL carriers from CP-OFDM to DFT-S-OFDM in order to obtain the small MPR.

As illustrated in FIG. 1, the two waveforms are presented—with DFT-S-OFDM 102 and CP-OFDM 104. In FIGS. 1, 106 and 108, P_{CMAX_L,c} for serving cell c in CA case is lower than in non-CA case, due to a larger MPR for CA case. 110 and 112 show PUSCH transmission power P_{PUSCH,b,f,c}(i, j, q_{d}, l) when signaling of dualPA-architecture IE is absent. It can be observed that for intra-band contiguous UL CA in FR1, if the waveforms of both carriers are switched from CP-OFDM to DFT-S-OFDM, P_{CMAX} is increased by 0.5˜1 dB, which is the total increase of UE Tx power on both carriers caused by waveform switching.

### Inter-Band UL CA

As specified in 38.101-1, “For inter-band carrier aggregation with uplink assigned to two NR bands, the requirements in clause 6.2.2 apply for each uplink component carrier.” In other words, for inter-band UL carrier aggregation, MPR for each component carrier is determined according to the non-CA case. So P_{CMAX_L,f,c} for each serving cell c is the same as that of non-CA case.

The equation of P_{CMAX_L} for inter-band CA is as follows. Configured transmitted power for Inter-band CA has its lower bound determined by 10 log₁₀Σ [P_{PowerClass.c}/(MAX(mpr_{c}·Δmpr_{c}, a-mpr_{c})·Dt_{C,c}·Dt_{IB,c}·Dt_{RxSRS,c}] across serving cells, which adds up across CC and can be larger than P_{PowerClass,CA}−ΔP_{PowerClass, CA}. Therefore, for inter-band UL CA in FR1, P_{PowerClass, CA} is the most limiting factor for P_{CMAX_L}. Note that P_{PowerClass, CA} is independent from MPR and waveform.

$${P}_{CMAX \_ L} = MIN \{ 10 {log}_{10} \sum MIN [ {p}_{EMAX , c} / {Dt}_{C , c} ) , {p}_{PowerClass . c} / ( MAX ( {mprc}_{c} \cdot Δ {mpr}_{c} , a - {mpr}_{c} ) \cdot {Dt}_{C , c} \cdot {Dt}_{IB , c} \cdot {Dt}_{RxSRS , c} ) , {p}_{Powerclass , c} / {pmpr}_{c} ] , {P}_{EMAX , CA} , {P}_{PowerClass , CA} - Δ {P}_{PowerClass , CA} \} ( inter - band CA )$$

$${P}_{CMAX \_ L , f , c} = MIN \{ {P}_{EMAX , c} - Δ {T}_{C , c} , ( {P}_{PowerClass} - Δ {P}_{PowerClass} ) - MAX ( MAX ( {MPR}_{c} + Δ {MPR}_{c} , A - {MPR}_{c} ) + Δ {T}_{IB , c} + Δ {T}_{C , c} + Δ {T}_{RXSRS} , P - {MPR}_{c} ) \} ( non - CA case , inter - band CA ) .$$

An example of this is given in FIG. 2.

### UL CA in FR2

The configured UE maximum output power P_{CMAX} shall be set such that the corresponding measured total peak EIRP P_{UMAX} is within the following bounds:

$${P}_{Powerclass} - MAX ( MAX ( MPR , A - MPR ) + Δ {MB}_{P , n} , P - MPR ) - MAX \{ T ( MAX ( MPR , A - MPR ) ) , T ( P - MPR ) \} \leq {P}_{UMAX} \leq {EIRP}_{max}$$

$${P}_{Powerclass} + {DP}_{IBE} - MAX ( MAX ( {MPR}_{f , c} , A - {MPR}_{f , c} , ) + Δ {MB}_{P , n} , P - {MPR}_{f , c} ) - MAX \{ T ( MAX ( {MPR}_{f , c} , A - {MPR}_{f , c} , ) ) , T ( P - {MPR}_{f , c} ) \} \leq {P}_{UMAX , f , c} \leq {EIRP}_{max}$$

In FR2, intra-band contiguous CA is supported for power class 3. Table 6.2A.2.4-1: Maximum power reduction (MPRC_CA) for UE power class 3 in 38.101-2 shows nearly the same MPR for two waveforms under the same modulation order and Cumulative aggregated channel bandwidth (CABW). However, there is an exception for DFT-s-BPSK or DFT-s-QPSK UL allocation, as copied below, where MPR of intra-band contiguous UL CA is determined by MPR of non-CA configuration.

In case of a contiguous RB, DFT-s-BPSK or DFT-s-QPSK UL allocation in a single CC of a CA configuration with contiguous CCs, and whose cumulative aggregated BW £ 400 MHz, MPR_{C_CA} shall be derived instead as MAX(MPR₁, MPR₂), where:
MPR₁ shall be determined from Table 6.2.2.3-1 if CABW≤200 MHz, from Table 6.2.2.3-2 if CABW>200 MHz.
MPR₂ shall be determined from Table 6.2.2.3-1 if UL BW_{channel_CA}≤200 MHz, from Table 6.2.2.3-2 if UL BW_{channel_CA}>200 MHz.

According to Table 6.2.2.3-1 and Table 6.2A.2.4-1 in 38.101-2, FIG. 3 shows an example of for power class 3, BW_{channel}≤200 MHz, FR2-1 QPSK and outer RB allocation, MPR for DFT-S-OFDM and CP-OFDM are 2 and 4 dB respectively. In the case of intra-band contiguous UL CA in FR2 304 with contiguous allocations within the cumulative aggregated bandwidth≤400 MHz, MPR for CP-OFDM can be 5 dB. But in case of a contiguous RB, DFT-s-QPSK UL allocation in a single CC of a CA configuration with contiguous CCs, and whose cumulative aggregated BW≤400 MHz, MPR_{C_CA} should refer to non-CA case, namely 2 dB. 306 and 308 of FIG. 3 show P_{PUSCH}. For intra-band contiguous UL CA in FR2, when both two carriers are switched from CP-OFDM to DFT-S-OFDM, potential 3 dB increase of P_{CMAX} can be achieved. 2 more dB is possible if it is inner RB allocation for DFT-S-OFDM.

With the above analysis, it can be observed that for power class 3 UE, UL waveform switching can bring a non-negligible transmit power increase for intra-band contiguous UL CA in FR2.

### 2.1.5 Rel-18 Dynamic Waveform Switching

UL waveform for PUSCH transmission is configured by RRC, and therefore UL waveform switching based on RRC reconfiguration is supported since NR Rel-15. Dynamic UL waveform switching was proposed to Rel-17 TEI in RAN1 #106 bis R1-2109024, with the following alternatives and not agreed. It was included in Rel-18 Further NR coverage enhancement WI.

To support dynamic switching of UL waveform, few alternatives can be considered:
Alt1: DCI signaling based dynamic UL waveform switching, it could be implicit or explicit
   Alt1-1: Explicit signaling, e.g., by introducing 1 bit in DCI to indicate CP-OFDM or DFT-s-OFDM waveform to be used for PUSCH.
   Alt1-2: Implicit signaling, e.g., CP-OFDM or DFT-s-OFDM waveform to be used for PUSCH is identified by certain condition on the scheduling information in the DCI without changing DCI format.
Alt2: MAC CE signaling based dynamic UL waveform switching.

Options of implicit signaling of UL waveform switching without changing DCI format:
Opt.1: waveform is DFT-S-OFDM if contiguous PRB allocation and multiple value of 2, 3, 5, else CP-OFDM.
Opt.2: waveform is DFT-S-OFDM if the Modulation and Coding Scheme (MCS) is lower than a threshold, else CP-OFDM.
Opt.3: waveform is CP-OFDM if PUSCH and DMRS is FDMed (based on ‘Number of DMRS CDM group(s) without data’), else DFT-S-OFDM.
Opt.4: waveform is CP-OFDM if more than one layer/rank are indicated, else DFT-S-OFDM.

One or multiple conditions can be used to determine whether the UE applies DFT-s-OFDM waveform in UL transmission.

A UE determines the PUSCH transmission power P_{PUSCH, b,f,c}(i, j, q_{d}, l) in a PUSCH transmission occasion i as follows:

$${P}_{PUSCH , b , f , c} ( i , j , {q}_{d} , l ) = min \{ \begin{matrix}{P}_{CMAX , f , c} ( i ) , \\ \begin{matrix}{P}_{O\_PUSCH , b , f , c} ( j ) + 10 {log}_{10} ( {2}^{μ} \cdot {M}_{RB , b , f , c}^{PUSCH} ( i ) ) + {a}_{b , f , c} ( j ) \cdot \\ {PL}_{b , f , c} ( {q}_{d} ) + {Δ}_{TF , b , c} ( i ) + {f}_{b , f , c} ( i , l )\end{matrix}\end{matrix} \} [ dBm ]$$

PUSCH transmission power is bounded by UE configured maximum output power, P_{CMAX,f,c}(i). If the required PUSCH transmission power determined by

$${P}_{O \_ PUSCH , b , f , c} ( j ) + 10 {log}_{10} ( {2}^{μ} \cdot {M}_{RB , b , f , c}^{PUSCH} ( i ) ) + {a}_{b , f , c} ( j ) \cdot {PL}_{b , f , c} ( {q}_{d} ) + {Δ}_{TF , b , f , c} ( i ) + {f}_{b , f , c} ( i , l )$$

is larger than P_{CMAX,f,c}(i) of the current UL waveform CP-OFDM, the UE is power limited. In order to evaluate whether UL waveform switching can improve the UE's UL coverage, gNB needs the information about the target waveform DFT-S-OFDM, e.g., if P_{CMAX,f,c} of DFT-S-OFDM is larger than the required PUSCH transmission power. As illustrated in FIG. 4, the solid line 402 shows the required PUSCH transmission power, higher than P_{CMAX,f,c} of CP-OFDM 404. The two bars 406 and 408 on its right side show two possible P_{CMAX,f,c} Of DFT-S-OFDM. The bar 406 is lower than the required PUSCH transmission power, so the UE would still be power limited after waveform switching. The bar 408 is higher than the UE required PUSCH transmission power, and the UL waveform switching can improve UL coverage.

### Agreement in RAN1 #110b

To study and if necessary, specify, enhancements to assist the scheduler in determining waveform switching, such as:
Reporting power headroom related information
Other solutions are not precluded.

### SUMMARY

Systems and method provide for uplink carrier aggregation (UL CA) that is configured for a User Equipment (UE), and transmissions on multiple UL carriers by one power amplifier (PA). When a base station (e.g., a gNB) indicates the UE should switch its UL waveform from Cyclic-Prefix Orthogonal Frequency Division Multiplexing (CP-OFDM) to Discrete Fourier Transform Spread OFDM (DFT-S-OFDM) for Physical Uplink Shared Channel (PUSCH) transmission in one or more UL carriers, the base station expects that the UE transmit power on a particular carrier can be increased, the carrier for which an UL coverage issue (e.g., low signal strength, signal to noise ratio, interference, etc.) is found. UL waveform switching from CP-OFDM to DFT-S-OFDM can improve the lower bound of PCMAX, namely the total UE transmit power on UL carriers of intra-band CA. It would be undesirable that the UE prioritizes power allocation in an UL carrier that does not have an UL coverage issue, and this present disclosure provides a method to solve this problem.

In an embodiment, a method can be provided that can be implemented in a base station for configuring UL CA for a UE. The method can include providing a first indication to the UE that the waveforms of one or more PUSCH transmissions in one or more corresponding uplink, UL, carriers are to be switched from a CP-OFDM waveform to a DFT-S-OFDM waveform. The method can also include providing a second indication to the UE of a PUSCH transmission in a carrier of the one or more UL carriers in which the UE should prioritize power allocation.

In an embodiment, the second indication is either an explicit indication or an implicit indication.

In an embodiment, the first indication comprises the second indication.

In an embodiment, the second indication is implicit based on the first indication.

In an embodiment, the PUSCH transmission in the UL carrier in which the UE should prioritize power allocation is in an UL carrier in which the PUSCH transmission is switched from the CP-OFDM waveform to the DFT-S-OFDM waveform.

In an embodiment, the UL carrier is an only UL carrier in which the waveform of the PUSCH transmission is switched from the CP-OFDM waveform to the DFT-S-OFDM waveform of the UL carriers.

In an embodiment, the first indication and the second indication are provided to the UE via downlink control information.

In an embodiment, the providing the first indication is in response to receiving a Power Headroom Report from the UE.

In an embodiment, a base station configured to communication with a UE that is configured to perform UL CA can be provided, where the base station comprises radio interface and processing circuitry configured to cause the base station to perform the above methods.

In another embodiment, a method can be implemented in a UE for implementing UL CA. The method can include receiving a first indication from a base station that waveforms of one or more PUSCH transmissions in one or more corresponding UL carriers are to be switched from a CP-OFDM waveform to a DFT-S-OFDM waveform. The method can also include receiving a second indication from the base station of a PUSCH transmission in an UL carrier of the one or more UL carriers in which the UE should prioritize power allocation.

In an embodiment, the method can include prioritizing power allocation for the PUSCH transmission in the UL carrier of the one or more UL carriers at the PUSCH transmission occasion of the PUSCH transmission or until the PUSCH transmission is complete.

In an embodiment, the second indication is either an explicit indication or an implicit indication.

In an embodiment, the first indication comprises the second indication.

In an embodiment, the second indication is implicit based on the first indication.

In an embodiment, the PUSCH transmission in the UL carrier in which the UE prioritizes power allocation is in the UL carrier in which a waveform of the PUSCH transmission is switched from the CP-OFDM waveform to the DFT-S-OFDM waveform.

In an embodiment, the UL carrier is an only UL carrier switched from the CP-OFDM waveform to the DFT-S-OFDM waveform of the UL carriers.

In an embodiment, the first indication and the second indication are received via downlink control information.

In an embodiment, the receiving the first indication is in response to providing a Power Headroom Report to the base station.

In an embodiment, a UE can be provided to implement UL CA wherein the UE comprises a radio interface and processing circuitry configured to perform any of the above described methods pertaining to the UE.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates a chart depicting power levels in intra-band contiguous Uplink Carrier Aggregation (UL CA) according to some embodiments of the present disclosure;

FIG. 2 illustrates another chart depicting power levels in intra-band contiguous UL CA according to some embodiments of the present disclosure;

FIG. 3 illustrates another chart depicting power levels in intra-band contiguous UL CA according to some embodiments of the present disclosure;

FIG. 4 illustrates a chart depicting a maximum power vs required User Equipment (UE) transmission power according to some embodiments of the present disclosure;

FIG. 5 illustrates a single and dual power amplifier (PA) architecture for intra-band CA according to some embodiments of the present disclosure;

FIG. 6 illustrates a timeline of UE and base station behaviors for waveform switching according to some embodiments of the present disclosure;

FIG. 7 illustrates a chart depicting maximum power levels for UL CA according to some embodiments of the present disclosure;

FIG. 8 illustrates a chart depicting the effects Transmission Power Control (TPC) values according to some embodiments of the present disclosure;

FIG. 9 illustrates a flowchart of a method implemented in a base station for configuring UL CA for a UE according to some embodiments of the present disclosure;

FIG. 10 illustrates a flowchart of a method implemented in a UE for implementing UL CA according to some embodiments of the present disclosure;

FIG. 11 illustrates a flowchart of a method implemented in a UE for implementing UL CA according to some embodiments of the present disclosure;

FIG. 12 illustrates a flowchart of a method implemented in a UE for implementing UL CA according to some embodiments of the present disclosure;

FIG. 13 illustrates one example of a cellular communications system according to some embodiments of the present disclosure;

FIG. 14 is a schematic block diagram of a radio access node according to some embodiments of the present disclosure;

FIG. 15 is a schematic block diagram that illustrates a virtualized embodiment of the radio access node of FIG. 14 according to some embodiments of the present disclosure;

FIG. 16 is a schematic block diagram of the radio access node of FIG. 14 according to some other embodiments of the present disclosure;

FIG. 17 is a schematic block diagram of a UE according to some embodiments of the present disclosure; and

FIG. 18 is a schematic block diagram of the UE of FIG. 17 according to some other embodiments of the present disclosure.

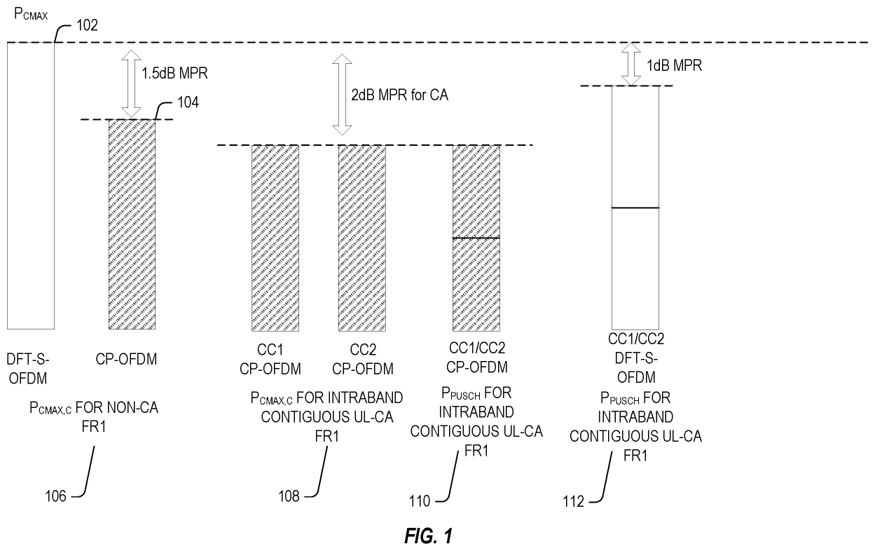

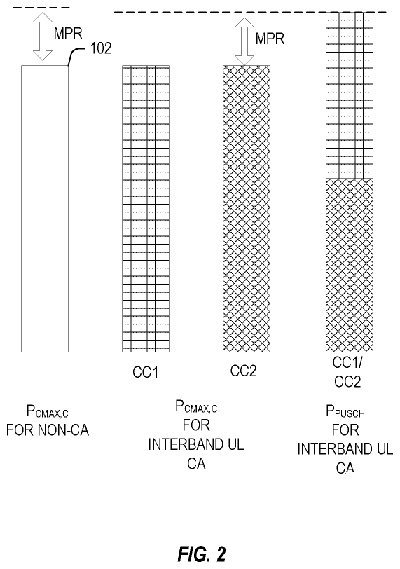

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station or a network node that implements a gNB Distributed Unit (gNB-DU)) or a network node that implements part of the functionality of some other type of radio access node.

Network Node: As used herein, a “network node” is any node that is either part of the RAN or the core network of a cellular communications network/system.

In some embodiments, a set of TRPs is a set of geographically co-located antennas (e.g., an antenna array (with one or more antenna elements)) supporting TP and/or Reception Point (RP) functionality.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

Systems and method provide for uplink carrier aggregation (UL CA) that is configured for a User Equipment (UE), and transmissions on multiple UL carriers by one power amplifier (PA). When a base station (e.g., a gNB) indicates the UE should switch its UL waveform from Cyclic-Prefix Orthogonal Frequency Division Multiplexing (CP-OFDM) to Discrete Fourier Transform Spread OFDM (DFT-S-OFDM) for Physical Uplink Shared Channel (PUSCH) transmission in one or more UL carriers, the base station expects that the UE transmit power on a particular carrier can be increased, the carrier for which an UL coverage issue (e.g., low signal strength, signal to noise ratio, interference, etc.) is found. UL waveform switching from CP-OFDM to DFT-S-OFDM can improve the lower bound of PCMAX, namely the total UE transmit power on UL carriers of intra-band CA. It would be undesirable that the UE prioritizes power allocation in an UL carrier that does not have an UL coverage issue, and this present disclosure provides a method to solve this problem.

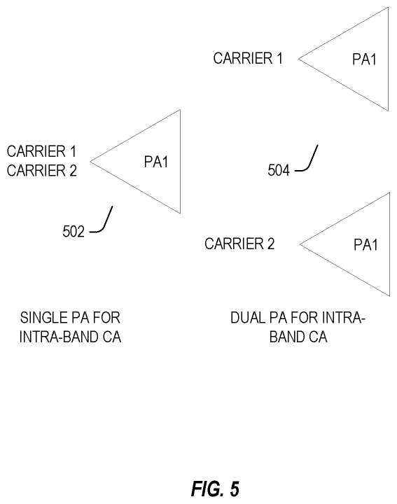

There currently exist certain challenge(s). For UEs supporting UL CA, it is up to UE implementation on the mapping of UL carriers on Power Amplifiers (PAS). For single-band UL CA, a UE indicates the support of dual PA by dualPA-Architecture. There is no power sharing between the transmissions on different PAS, as illustrated in FIG. 5 at 504. If dualPA-Architecture is absent in such band combinations, the UE supports single PA for all the ULs, as illustrated in FIG. 5 at 502. With multiple UL carriers mapped to a single PA, a UE may support dynamic power sharing among the UL carriers. For intra-band CA, the present disclosure focuses on single PA architecture.

Maximum Power Reduction (MPR) and UE configured transmitted power are separately defined for non-CA configuration, intra-band CA and inter-band CA in FR1 and FR2.

### 38.101-1, for Configured Transmitted Power for Intra-Band Contiguous CA

For Power Headroom (PH) reporting the following exception applies: if the UE is configured with multiple uplink serving cells, the power P_{CMAX,c} used for the purpose of PH reporting on first serving cell c=c₁ does not consider for computation of the PH report transmissions on a second serving cell c₂ as exempted in subclause 7.7.1 in [.

### 38.101-2 for Configured Transmitted Power for Intra-Band UL CA

The definition of the configured UE maximum output power P_{CMAX,f,c} for each carrier f of a serving cell cis used for power headroom reporting for carrier f of serving cell c only and is in accordance with that specified in clause 6.2.4 with parameters MPR, A-MPR and P-MPR replaced with those specified in subclause 6.2A.2, 6.2A.3 and 6.2.4, respectively.

### In 38.213 7.7.1 Type 1 PH Report

If a UE determines that a Type 1 power headroom report for an activated serving cell is based on an actual PUSCH transmission then, for PUSCH transmission occasion i on active UL BWP b of carrier f of serving cell c, the UE computes the Type 1 power headroom report as:

$${PH}_{type 1 , b , f , c} ( i , j , {q}_{d} , l ) = {P}_{CMAX , f , c} ( i ) - \{ {P}_{O\_PUSCH , b , f , c} ( j ) + 10 {log}_{10} ( {2}^{μ} \cdot {M}_{RB , b , f , c}^{PUSCH} ( i ) ) + {a}_{b , f , c} ( j ) \cdot {PL}_{b , f , c} ( {q}_{d} ) + {Δ}_{TF , b , f , c} ( i ) + {f}_{b , f , c} ( i , l ) \} [ dB ]$$

One problem is that if UL CA is configured and the UL coverage problem is only in one carrier, there is no guarantee that the transmit power increase introduced by UL waveform switching from CP-OFDM to DFT-S-OFDM can be allocated to the carrier which has UL coverage issue, because power sharing between UL carriers with single-PA architecture is up to UE implementation.

Certain aspects of the disclosure and their embodiments may provide solutions to these or other challenges. The present disclosure is directed to when UL CA is configured for a UE, and UL transmissions on multiple UL carriers are from one PA. For example, for intra-band UL CA, when the signalling is absent for dualPA-Architecture IE in such band combination, and the UE supports single PA for all the ULs.

When gNB indicates the UE to switch its UL waveform switching from CP-OFDM to DFT-S-OFDM, its purpose is to increase UE's transmit power on at least one UL carrier. Though it is possible that gNB configures UL waveform to be switched from DFT-S-OFDM to CP-OFDM, “waveform switching” in this section refers to switching from CP-OFDM to DFT-S-OFDM, unless otherwise stated.

Note that in FR2, the requirement of configured UE maximum output power P_{CMAX} is given in the form of the corresponding measured total peak EIRP P_{UMAX}, due to OTA measurement. But in FR1, P_{CMAX} is used directly. The present disclosure uses P_{CMAX} in both FR1 and FR2 for the sake of simplicity, while it actually refers to corresponding measured total peak EIRP P_{UMAX} in FR2.

### Power Allocation Across UL Carriers for Dynamic Waveform Switching

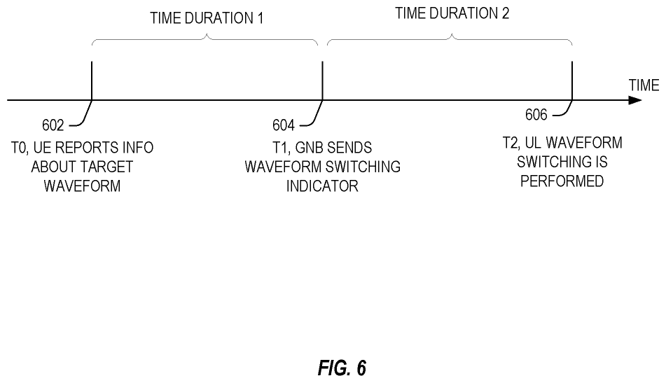

FIG. 6 shows the possible UE and gNB behaviors for waveform switching. A UE is configured with CP-OFDM as the waveform of PUSCH. At T0 602, a UE reports the information (e.g., P_{CMAX,f,c} and/or PH) for a carrier f and serving cell c about the target waveform on a scheduled transmission occasion at T2 606, which is different from the one currently used. The report can assist gNB's decision on waveform switching. At T1 604, gNB schedules a UL grant as well as the waveform of DFT-S-OFDM at T1 604. The UE transmits PUSCH as scheduled at T2 606 with the new waveform.

Take an example of UL CA with two UL carriers. The coverage of two UL component carriers may be not overlapping, especially when the base stations of different carriers are not co-located. A UE may suffer from UL coverage shortage in one of the multiple UL carriers, although gNB may switch UL waveforms of both carriers from CP-OFDM to DFT-S-OFDM to obtain the lower MPR. For a legacy UE with a single PA, power sharing between UL carriers is up to UE implementation. Certain embodiments relate to UE power sharing between UL carriers based on priority information provided by gNB. Another embodiment allows the UE to change power allocation and at the same time to inform gNB the change of power allocation from the previous UE report if there is any change of reporting value compared to previous reporting.

In one embodiment, if the UL CA is configured for a UE, the gNB indicates the PUSCH waveforms of one, several or all activated UL carriers are switched from CP-OFDM to DFT-S-OFDM. Among these carriers, gNB may explicitly or implicitly indicate the carrier(s), in which the UE is expected to prioritize power allocation for the PUSCH transmission(s).

In another embodiment, the carrier indication can be signaled separately or together with the waveform switching indication.

In another embodiment, if only one carrier of all activated UL carriers is indicated for UL waveform switching, it is the carrier for which the gNB identifies an UL coverage issue (or, more specifically, a PUSCH coverage issue) and expects the UE to prioritize in power allocation for a PUSCH transmission.

In another embodiment, in response to receiving an indication of prioritizing power allocation for a PUSCH transmission in carrier f of serving cell c, a UE prioritizes this carrier of the serving cell in power allocation at the PUSCH transmission occasion or until the PUSCH is transmitted.

Suppose the waveform indicator and carrier indicator are indicated in slot n, and both are for a later PUSCH transmission in slot m. If slot m follows closely after slot n (e.g., within a threshold number of slots), the UE can prioritize power allocation for the carrier from receiving the indication in slot n until the PUSCH transmission is complete in slot m. Otherwise, there may be a long period of time between slot n and slot m. If there is no PUSCH transmission in the indicated carrier during this time, the UE can prioritize power for UL transmissions in other carriers as long as power for the PUSCH transmission in the indicated carrier in slot m is prioritized. However, this is a more dynamic power allocation scheme across carriers and may increase UE complexity.

In another embodiment, the current PUSCH waveform is CP-OFDM, and a UE is configured/indicated to report power information of a carrier f of serving cell c about DFT-S-OFDM. Since the UE report is transmitted, the UE prioritizes this carrier of the serving cell in power allocation with one or more of the following conditions:
for a pre-determined or RRC/DCI configured timer
until receiving a signaling on waveform switching or prioritization of power allocation for a PUSCH transmission in a different carrier
until the next PDCCH monitoring occasion which may indicate a potential waveform switching.

Certain embodiments described above restrict UE power sharing during time duration 2 606, illustrated in FIG. 6. The embodiment described above, in which the current PUSCH waveform is CP-OFDM, and a UE is configured/indicated to report power information, accounts for the possibility that the power allocation among carriers may have changed during time duration 1 as well. Both embodiments take measures to mitigate the problem that the actual UE Tx power on the concerned UL carrier after waveform switching is smaller than the gNB estimate, which is based on the previous UE report.

In one embodiment, prioritizing carrier f of serving cell c in power allocation can be achieved by one or more of the following methods:
Method 1: The UE transmits the scheduled PUSCH in the indicated carrier with PUSCH transmission power P_{PUSCH,b,f,c}(i, j, q_{d}, l) equal to

$${P}_{O \_ PUSCH , b , f , c} ( j ) + {log}_{10} ( {2}^{μ} \cdot {M}_{RB , b , f , c}^{PUSCH} ( i ) ) + {α}_{b , f , c} ( j ) \cdot {PL}_{b , f , c} ( {q}_{d} ) + {Δ}_{T F , b , f , c} ( i ) + {f}_{b , f , c} ( i , l ) ,$$

where the parameters are defined in Section 7.1.1 in 38.213
Method 2: The UE is not expected to increase the estimated pathloss for carriers and serving cells other than carrier f and serving cell c from the previous estimation.
Method 3: The UE is not expected to increase transmission power for carriers and serving cells other than carrier f and serving cell c due to TPC command.

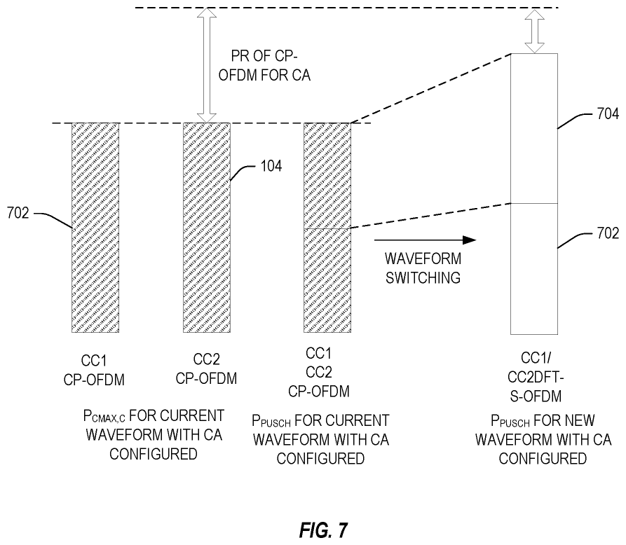

As illustrated in FIG. 7, a UE is configured with CP-OFDM for both carriers. CC2 704 has a UL PUSCH coverage issue. The UE later receives the signaling to switch UL waveforms of both CC1 702 and CC2 704. MPR of DFT-S-OFDM applies to both carrier of intra-band UL CA. P_{PUSCH} of CC1 702 is lower than that of CC2 704, which takes more advantage of the increased transmit power. If waveform switching to DFT-S-OFDM can increase transmission power more than the power shortage of CC2 for PUSCH transmission with CP-OFDM, and UE prioritizes power allocation according to Method 1 in the first bullet immediately above, the UE's PUSCH coverage issue in CC2 can be solved.

Section 7.5 in 38.213, copied above, specifies the priorities of different UL channels/signals, if a total UE transmit power for PUSCH or PUCCH or PRACH or SRS transmissions on serving cells in a frequency range in a respective transmission occasion i would exceed \hat{P}_{CMAX}(i), where \hat{P}_{CMAX}(i) is the linear value of P_{CMAX}(i) in transmission occasion i. PUSCH transmission can be of two priorities, according to whether UCI is multiplexed or not, as defined in section 7.5 in 38.214:
PUSCH transmission with HARQ-ACK information
PUSCH transmission without HARQ-ACK information or CSI

The abovementioned prioritization also applies for the condition in section 7.5 in 38.213, when multiple PUSCH transmissions on UL carriers are of same priority order, i.e., all of the either multiple PUSCH transmissions are either with HARQ-ACK transmission, or without HARQ-ACK information or CSI.

In one embodiment, if a total UE transmit power for PUSCH or PUCCH or PRACH or SRS transmissions on serving cells in a frequency range in a respective transmission occasion i would exceed \hat{P}_{CMAX}(i), where \hat{P}_{CMAX}(i) is the linear value of P_{CMAX}(i) in transmission occasion i as defined in [8-1, TS 38.101-1] for FR1 and [8-2, TS38.101-2] for FR2, and PUSCH transmissions in multiple carriers are of same priority order as defined in section 7.5 in 38.213, the UE prioritizes power allocation for transmissions on the carrier, as indicated in Embodiment 1.

An example of specification change to “PUSCH transmission without HARQ-ACK information or CSI” is as follows:

For single cell operation with two uplink carriers or for operation with carrier aggregation, if a total UE transmit power for PUSCH or PUCCH or PRACH or SRS transmissions on serving cells in a frequency range in a respective transmission occasion i would exceed \hat{P}_{CMAX}(i), where \hat{P}_{CMAX}(i) is the linear value of P_{CMAX}(i) in transmission occasion i as defined in [8-1, TS 38.101-1] for FR1 and [8-2, TS38.101-2] for FR2, the UE allocates power to PUSCH/PUCCH/PRACH/SRS transmissions according to the following priority order (in descending order) so that the total UE transmit power for transmissions on serving cells in the frequency range is smaller than or equal to \hat{P}_{CMAX}(i) for that frequency range in every symbol of transmission occasion i.
. . .
PRACH transmission on the Pcell
PUCCH transmission with HARQ-ACK information and/or SR or PUSCH transmission with HARQ-ACK information
PUCCH transmission with CSI or PUSCH transmission with CSI
PUSCH transmission without HARQ-ACK information or CSI, with UL waveform switched from CP-OFDM to DFT-S-OFDM, on the carrier indicated by gNB for UE to prioritize power allocation
PUSCH transmission without HARQ-ACK information or CSI, with UL waveform switched from CP-OFDM to DFT-S-OFDM, on the carrier indicated by gNB for UE to prioritize power allocation
PUSCH transmission without HARQ-ACK information or CSI
SRS transmission, with aperiodic SRS having higher priority than semi-persistent and/or periodic SRS, or PRACH transmission on a serving cell other than the Pcell

In one embodiment, after a UE transmits a PHR, it may have to change power allocation across UL carriers according to the current specification of PUSCH transmission power determination, for reasons including the change of PRB allocation, PL estimation change, Scell activation/deactivation, etc. A UE in such a case can transmit a new PHR to network to indicate the change. The benefit is that if the gNB hasn't signaled waveform switching command yet, it can re-evaluate the possible gain based on the updated PHR, otherwise at least gNB can foresee that PUSCH transmit power with the new waveform will be lower than its estimate based on the previous PHR.

### PUSCH Transmission Power Determination after Dynamic Waveform Switching

### **Begin Quote from Section 7.1.1 in 38.213**

If a UE transmits a PUSCH on active UL BWP b of carrier f of serving cell c using parameter set configuration with index j and PUSCH power control adjustment state with index l, the UE determines the PUSCH transmission power P_{PUSCH,b,f,c}(i, j, q_{d}, l) in PUSCH transmission occasion i as

$${P}_{PUSCH , b , f , c} ( i , j , {q}_{d} , l ) = min \{ \begin{matrix}{P}_{CMAX , f , c} ( i ) , \\ \begin{matrix}{P}_{O \_ PUSCH , b , f , c} ( j ) + 10 {log}_{10} ( {2}^{μ} \cdot {M}_{RB , b , f , c}^{PUSCH} ( i ) ) + \\ {α}_{b , f , c} ( j ) \cdot {PL}_{b , f , c} ( {q}_{d} ) + {Δ}_{TF , b , f , c} ( i ) + {f}_{b , f , c} ( i , l )\end{matrix}\end{matrix} \} [ dBm ] …$$

$${f}_{b , f , c} ( i , l ) = {f}_{b , f , c} ( i - {i}_{0} , l ) + {\sum }_{m = 0}^{C ( {D}_{i} ) - 1} {δ}_{PUSCH , b , f , c} ( m , l )$$

is the PUSCH power control adjustment state l for active UL BWP b of carrier f of serving cell c and PUSCH transmission occasion i if the UE is not provided tpc-Accumulation, where

$${\sum }_{m = 0}^{𝒞 ( {D}_{i} ) - 1} {δ}_{PUSCH , b , f , c} ( m , l )$$

is a sum of TPC command values in a set Dᵢ od TPC cardinality C(Dᵢ) that the UE receives between K_{PUSCH}(i−i₀)−1 symbols before PUSCH transmission occasion i−i₀ and K_{PUSCH}(i) symbols before PUSCH transmission occasion i on active UL BWP b of carrier f of serving cell c for PUSCH power control adjustment state l, where i₀>0 is the smallest integer for which K_{PUSCH}(i−i₀) symbols before PUSCH transmission occasion i−i₀ is earlier than K_{PUSCH}(i) symbols before PUSCH transmission occasion i b of
A UE resets accumulation of a PUSCH power control adjustment state l for active UL BWP b of carrier f of serving cell c to f_{b,f,c}(k, l)=0, k=0, 1, . . . , i
   If a configuration for a corresponding P_{O_UE_PUSCH,b,f,c}(j) value is provided by higher layers
   If a configuration for a corresponding α_{b,f,c}(j) value is provided by higher layers

### **End Quote from Section 7.1.1 in 38.213**

The present disclosure simplifies the equation of P_{PUSCH,b,f,c}(i, j, q_{d}, l) as:

$${P}_{PUSCH} = min ( x , y ) ,$$

where:
x is P_{CMAX,f,c}(i)
y is

$${P}_{O \_ PUSCH , b , f , c} ( j ) + 10 {log}_{10} ( {2}^{μ} \cdot {M}_{RB , b , f , c}^{PUSCH} ( i ) ) + {α}_{b , f , c} ( j ) \cdot {PL}_{b , f , c} ( {q}_{d} ) + {Δ}_{TF , b , f , c} ( i ) + {f}_{b , f , c} ( i , l ) ,$$

also called UE required PUSCH transmission power.

If the UE is not provided tpc-Accumulation,

$${f}_{b , f , c} ( i , l ) = {f}_{b , f , c} ( i - {i}_{0} , l ) + {\sum }_{m = 0}^{C ( {D}_{i} ) - 1} {δ}_{P U S C H , b , f , c} ( m , l )$$

indicates that f_{b,f,c}(i, l) is determined based on the value in the previous time occasion i−i₀ and the sum of TPC command values received generally during the gap. The sum of TPC command values, denoted by z, is actually the gNB expectation of the increase of P_{PUSCH}, rather than the increase of y, because gNB is unaware of which is smaller, x or y. However, in the specification, z is represented in the equation of f_{b,f,c}(i, l) and finally added to y. This make sense when x>y, TPC command can translate to an increased P_{PUSCH}. The present disclosure focuses on UEs at cell edge, where x<y. P_{PUSCH}=x, even if gNB expect the P_{PUSCH} to be increased by z, reaching x+Z.

After UL waveform is switched from CP-OFDM to DFT-S-OFDM, P′_{PUSCH}=min (x′, y′), where:
P′_{PUSCH} equals the UE transmit power after waveform switching, in a later time instance than P_{PUSCH},
x′ is P_{CMAX,f,c} of DFT-S-OFDM,
y′=y+z. According to the current disclosure, z is added to y.

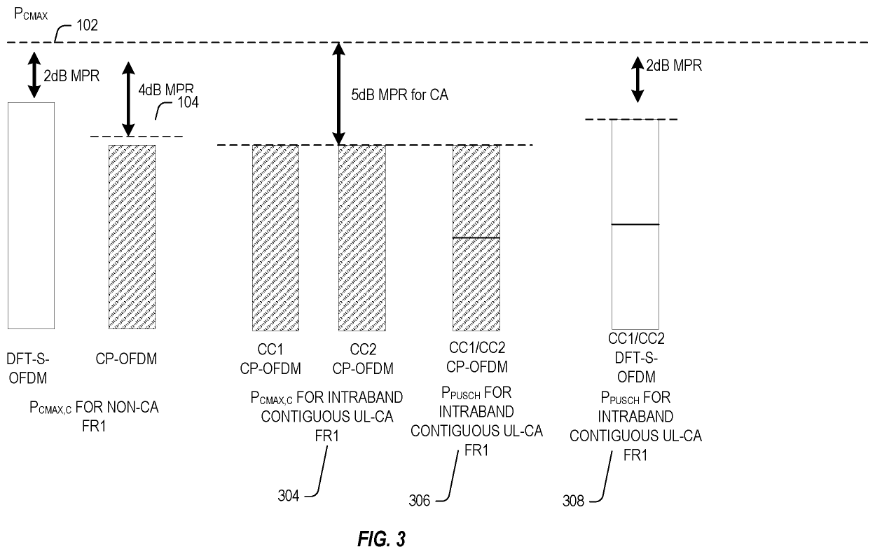

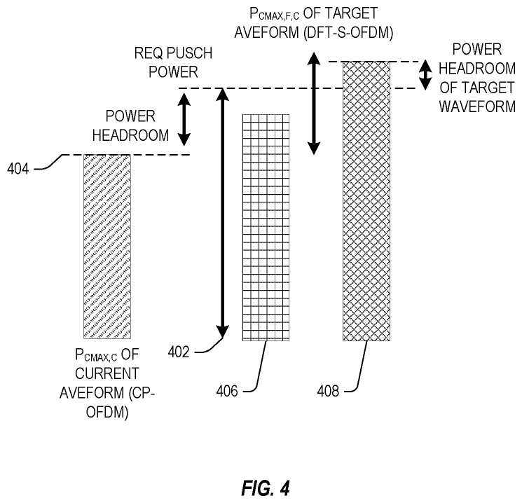

The present disclosure considers two cases:
1) If x′>y′, P′_{PUSCH}=y′=y+z. If x<y, P′_{PUSCH} of y+z after waveform switching is higher than gNB expected UE transmit power of x+z. This is illustrated in FIG. 3.
2) If x′<y′, P′_{PUSCH}=X′. The increased UE transmit power due to waveform switching equals x′−x. If this is larger than z, the UE transmits PUSCH with higher Tx power than what is expected by gNB. If x′−x is smaller than z, the UE transmits with P_{CMAX,f,c} and still miss the gNB expectation.

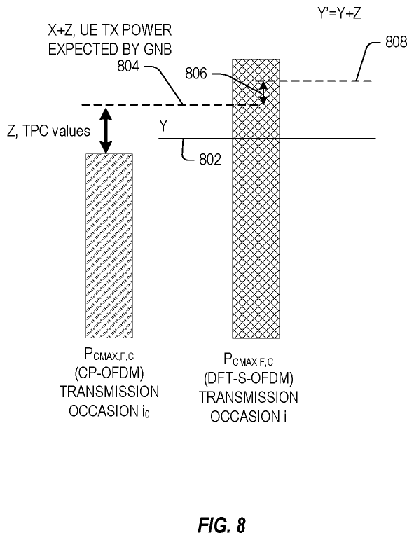

In FIG. 8, the solid line 802 show the required PUSCH transmission power determined by

$${P}_{O \_ P USCH , b , f , c} ( j ) + {log}_{10} ( {2}^{μ} \cdot {M}_{RB , b , f , c}^{PUSCH} ( i ) ) + {α}_{b , f , c} ( j ) \cdot {PL}_{b , f , c} ( {q}_{d} ) + {Δ}_{T F , b , f , c} ( i ) + {f}_{b , f , c} ( i , l )$$

at different transmission occasions. At transmission occasion i₀, the UE is power limited. Some TPC commands are received between the two transmission occasions, the dotted line 804 shows the UE transmit power expected by gNB, with TPC commands applied to P_{CMAX}At transmission occasion i, TPC values are added to the previous y. The solid line 808 of y′ is the UE transmit power after waveform switching, which is higher than dotted line 804 of gNB-expected UE Tx power. The arrow 806 shows the extra unnecessary transmission power.

It can be observed that:
TPC command values are gNB expected increase of UE transmit power, P_{PUSCH,b,f,c}(i, j, q_{d}, l), although they are added to the parameter of

$${P}_{O \_ P USCH , b , f , c} ( j ) + {log}_{10} ( {2}^{μ} \cdot {M}_{RB , b , f , c}^{PUSCH} ( i ) ) + {α}_{b , f , c} ( j ) \cdot {PL}_{b , f , c} ( {q}_{d} ) + {Δ}_{T F , b , f , c} ( i ) + {f}_{b , f , c} ( i , l ) .$$

According to

$${f}_{b , f , c} ( i , l ) = {f}_{b , f , c} ( i - {i}_{0} , l ) + {\sum }_{m = 0}^{C ( {D}_{i} ) - 1} {δ}_{P U S C H , b , f , c} ( m , l ) ,$$

after waveform switching from CP-OFDM to DFT-S-OFDM, the UE may transmit PUSCH with higher power than what gNB expects, namely the increase of UE transmit power is larger than the sum of TPC command values.

In one embodiment, upon receiving signaling of waveform switching from CP-OFDM to DFT-S-OFDM for a PUSCH transmission in transmission occasion i, if the UE is not provided tpc-Accumulation, one or more of the following methods are used to determine power for the PUSCH transmission:

$$Option 1 ,$$

$${P}_{PUSCH , b , f , c} ( i , j , {q}_{d} , l ) = min \{ \begin{matrix}{P}_{CMAX , f , c} ( i ) , \\ \begin{matrix}{P}_{CMAX , f , c}^{′} ( i - {i}_{0} ) + {\sum }_{m = 0}^{C ( {D}_{i} ) - 1} {δ}_{P U S C H , b , f , c} ( m , l ) , \\ {P}_{O \_ P USCH , b , f , c} ( j ) + {log}_{10} ( {2}^{μ} \cdot {M}_{RB , b , f , c}^{PUSCH} ( i ) ) + {α}_{b , f , c} ( j ) \cdot \\ {PL}_{b , f , c} ( {q}_{d} ) + {Δ}_{T F , b , f , c} ( i ) + {f}_{b , f , c} ( i , l )\end{matrix}\end{matrix} \} [ dBm ]$$

where, P′_{CMAX,f,c} is the P′_{CMAX,f,c} of a different waveform than the one being used, namely CP-OFDM in this case, and definitions of i₀ and

$${\sum }_{m = 0}^{C ( {D}_{i} ) - 1} {δ}_{P U S C H , b , f , c} ( m , l )$$

Option 2, the UE resets accumulation of a PUSCH power control adjustment state l for active UL BWP b of carrier f of serving cell c to f_{b,f,c}(k, l)=0, k=0, 1, . . . , i.

With Option 1, a new parameter is added, which equals the P_{CMAX} of CP-OFDM and the sum of TPC command values, as illustrated in FIG. 8.

FIG. 9 illustrates a flowchart of a method implemented in a base station for configuring UL CA for a UE according to some embodiments of the present disclosure.

At step 902 the method includes providing a first indication to the UE that the waveforms of one or more PUSCH transmissions in one or more corresponding uplink, UL, carriers are to be switched from a CP-OFDM waveform to a DFT-S-OFDM waveform.

At step 904, the method includes providing a second indication to the UE of a carrier of the one or more UL carriers in which the UE should prioritize power allocation for the corresponding PUSCH transmission.

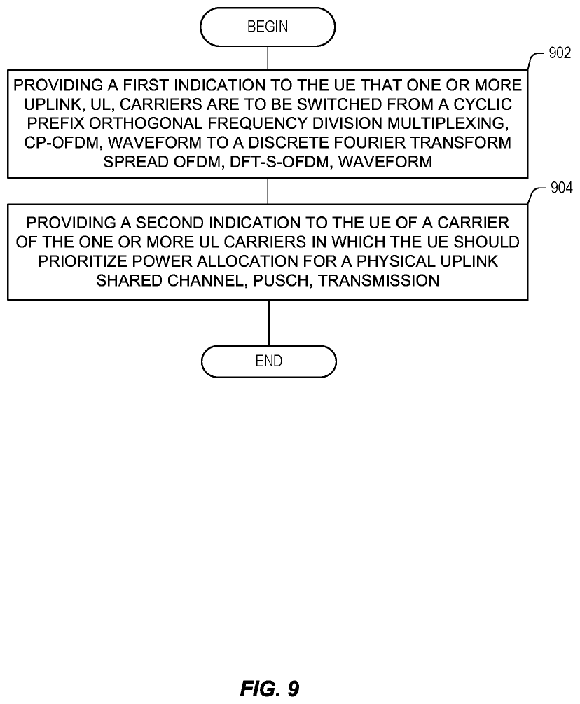

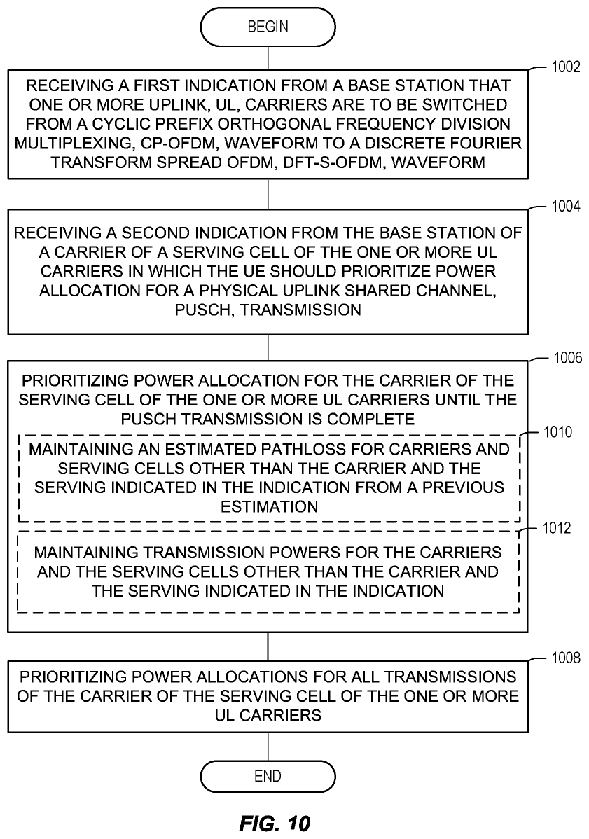

FIG. 10 illustrates a flowchart of a method implemented in a UE for implementing UL CA according to some embodiments of the present disclosure.

At step 1002 the method includes receiving a first indication from a base station that the waveforms of one or more PUSCH transmissions in one or more corresponding uplink, UL, carriers are to be switched from a CP-OFDM waveform to a DFT-S-OFDM waveform.

At step 1004 the method includes receiving a second indication from the base station of a carrier of the one or more UL carriers in which the UE should prioritize power allocation for the PUSCH transmission corresponding to the indicated carrier.

At step 1006 the method includes prioritizing power allocation for the carrier of the one or more UL carriers at the PUSCH transmission occasion of the PUSCH transmission or until the PUSCH transmission is complete. Step 1006 can include the optional step 1010 of refraining from increasing (or maintaining) an estimated pathloss for carriers and serving cells other than the carrier and the serving indicated in the indication from a previous estimation. Step 1006 can also include the optional step of 1012 of refraining from increasing (or maintaining) transmission powers for the carriers other than the carrier indicated in the indication due to a TPC command. Step 1006 can also include the optional step initiating the PUSCH transmission in the indicated carrier with PUSCH transmission power P_{PUSCH,b,f,c} (i, j, q_{d}, l) equal to:

$${P}_{O \_ P USCH , b , f , c} ( j ) + {log}_{10} ( {2}^{μ} \cdot {M}_{RB , b , f , c}^{PUSCH} ( i ) ) + {α}_{b , f , c} ( j ) \cdot {PL}_{b , f , c} ( {q}_{d} ) + {Δ}_{T F , b , f , c} ( i ) + {f}_{b , f , c} ( i , l ) .$$

At step 1008, the method includes prioritizing power allocations for all the PUSCH transmission of the carrier of the one or more UL carriers in response to a total UE transmit power for any of the following transmissions on serving cells in a predefined frequency range in a transmission occasion exceeds a predefined maximum power and PUSCH transmissions in multiple carriers are of a same priority order: the PUSCH transmission, a Physical Uplink Control Channel, PUCCH, transmission, a Physical Random Access Channel, PRACH, transmission, or a Sounding Reference Signal, SRS, transmission.

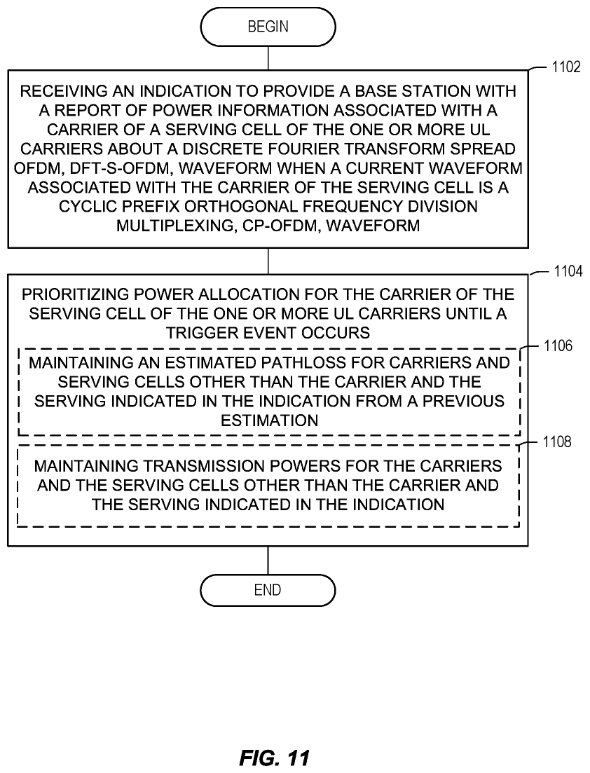

FIG. 11 illustrates a flowchart of a method implemented in a UE for implementing UL CA according to some embodiments of the present disclosure.

Step 1102 includes receiving an indication to provide a base station with a report of power information associated with a carrier of a serving cell of the one or more UL carriers about a DFT-S-OFDM waveform when a current waveform associated with the carrier of the serving cell is a CP-OFDM waveform.

Step 1104 includes prioritizing power allocation for the carrier of the serving cell of the one or more UL carriers starting from when the report is transmitted until a trigger event occurs. Step 1104 may optionally include the additional steps of 1106 and 1108. Step 1106 includes refraining from increasing (or maintaining) an estimated pathloss for carriers other than the carrier indicated in the indication from a previous estimation. Step 1108 includes refraining from increasing (or maintaining) transmission powers for the carriers other than the carrier indicated in the indication due to a TPC command.

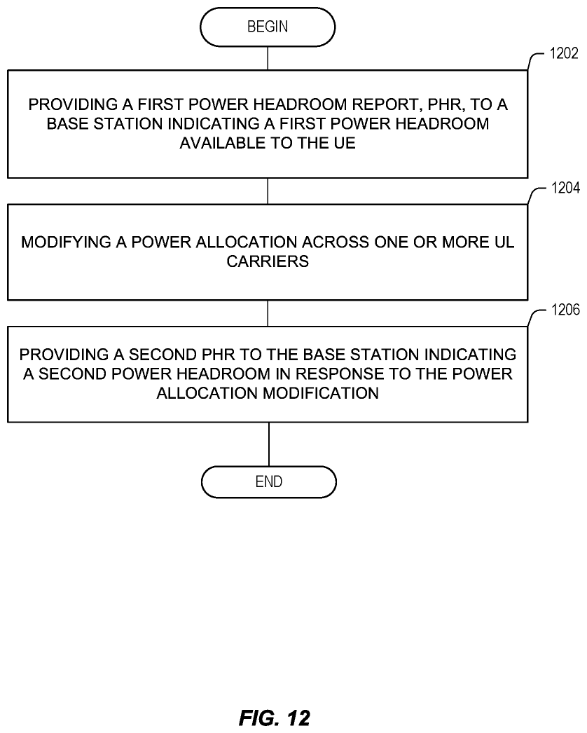

FIG. 12 illustrates a flowchart of a method implemented in a UE for implementing UL CA according to some embodiments of the present disclosure.

Step 1202 includes providing a first power headroom report to a base station indicating a first power headroom available to the UE.

Step 1204 includes modifying a power allocation across one or more UL carriers.

Step 1206 includes providing a second PHR to the base station indicating a second power headroom in response to the power allocation modification

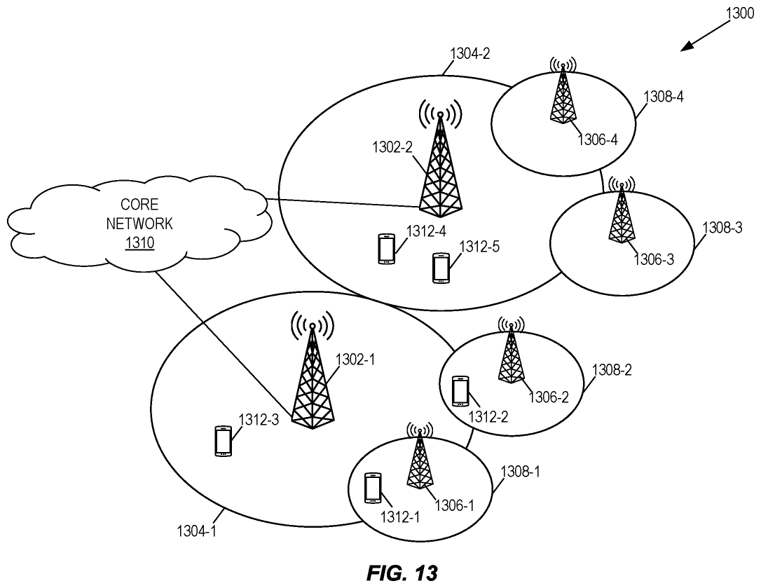

FIG. 13 illustrates one example of a cellular communications system 1300 in which embodiments of the present disclosure may be implemented. In the embodiments described herein, the cellular communications system 1300 is a 5G system (5GS) including a Next Generation RAN (NG-RAN) and a 5G Core (5GC) or an Evolved Packet System (EPS) including an Evolved Universal Terrestrial RAN (E-UTRAN) and an Evolved Packet Core (EPC). In this example, the RAN includes base stations 1302-1 and 1302-2, which in the 5GS include NR base stations (gNBs) and optionally next generation eNBs (ng-eNBs) (e.g., LTE RAN nodes connected to the 5GC) and in the EPS include eNBs controlling corresponding (macro) cells 1304-1 and 1304-2. The base stations 1302-1 and 1302-2 are generally referred to herein collectively as base stations 1302 and individually as base station 1302. Likewise, the (macro) cells 1304-1 and 1304-2 are generally referred to herein collectively as (macro) cells 1304 and individually as (macro) cell 1304. The base stations 1302-1 and 1302-2 can perform the functionality described with regard to FIG. 9. The RAN may also include a number of low power nodes 1306-1 through 1306-4 controlling corresponding small cells 1308-1 through 1308-4. The low power nodes 1306-1 through 1306-4 can be small base stations (such as pico or femto base stations) or RRHs, or the like. Notably, while not illustrated, one or more of the small cells 1308-1 through 1308-4 may alternatively be provided by the base stations 1302. The low power nodes 1306-1 through 1306-4 are generally referred to herein collectively as low power nodes 1306 and individually as low power node 1306. Likewise, the small cells 1308-1 through 1308-4 are generally referred to herein collectively as small cells 1308 and individually as small cell 1308. The cellular communications system 1300 also includes a core network 1310, which in the 5G System (5GS) is referred to as the 5GC. The base stations 1302 (and optionally the low power nodes 1306) are connected to the core network 1310.

The base stations 1302 and the low power nodes 1306 provide service to wireless communication devices 1312-1 through 1312-5 in the corresponding cells 1304 and 1308. The wireless communication devices 1312-1 through 1312-5 are generally referred to herein collectively as wireless communication devices 1312 and individually as wireless communication device 1312. In the following description, the wireless communication devices 1312 are UEs, but the present disclosure is not limited thereto. In an embodiment, the wireless communication devices 1312 can perform the functionality of the UEs as described in FIGS. 10-12 herein.

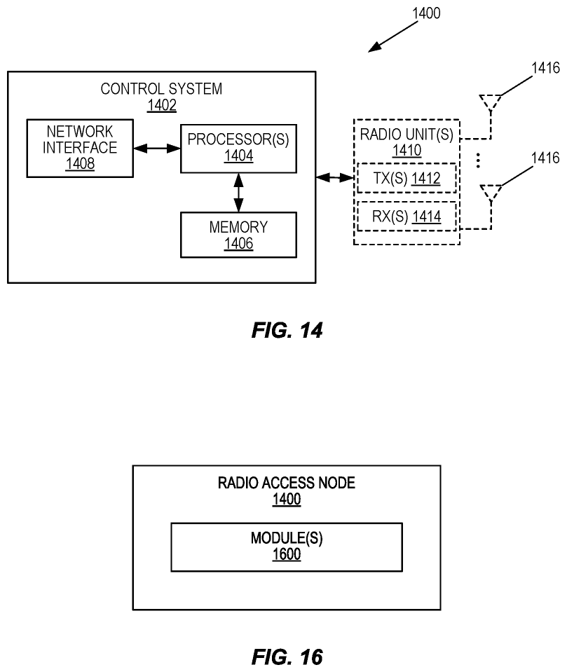

FIG. 14 is a schematic block diagram of a radio access node 1400 according to some embodiments of the present disclosure. Optional features are represented by dashed boxes. The radio access node 1400 may be, for example, a base station 1302 or 1306 or a network node that implements all or part of the functionality of the base station 1302 or gNB described herein and including the functionality described in FIG. 9. As illustrated, the radio access node 1400 includes a control system 1402 that includes one or more processors 1404 (e.g., Central Processing Units (CPUs), Application Specific Integrated Circuits (ASICs), Field Programmable Gate Arrays (FPGAs), and/or the like), memory 1406, and a network interface 1408. The one or more processors 1404 are also referred to herein as processing circuitry. In addition, the radio access node 1400 may include one or more radio units 1410 that each includes one or more transmitters 1412 and one or more receivers 1414 coupled to one or more antennas 1416. The radio units 1410 may be referred to or be part of radio interface circuitry. In some embodiments, the radio unit(s) 1410 is external to the control system 1402 and connected to the control system 1402 via, e.g., a wired connection (e.g., an optical cable). However, in some other embodiments, the radio unit(s) 1410 and potentially the antenna(s) 1416 are integrated together with the control system 1402. The one or more processors 1404 operate to provide one or more functions of a radio access node 1400 as described herein. In some embodiments, the function(s) are implemented in software that is stored, e.g., in the memory 1406 and executed by the one or more processors 1404.

FIG. 15 is a schematic block diagram that illustrates a virtualized embodiment of the radio access node 1400 according to some embodiments of the present disclosure. This discussion is equally applicable to other types of network nodes. Further, other types of network nodes may have similar virtualized architectures. Again, optional features are represented by dashed boxes.

As used herein, a “virtualized” radio access node is an implementation of the radio access node 1400 in which at least a portion of the functionality of the radio access node 1400 is implemented as a virtual component(s) (e.g., via a virtual machine(s) executing on a physical processing node(s) in a network(s)). As illustrated, in this example, the radio access node 1400 may include the control system 1402 and/or the one or more radio units 1410, as described above. The control system 1402 may be connected to the radio unit(s) 1410 via, for example, an optical cable or the like. The radio access node 1400 includes one or more processing nodes 1500 coupled to or included as part of a network(s) 1502. If present, the control system 1402 or the radio unit(s) are connected to the processing node(s) 1500 via the network 1502. Each processing node 1500 includes one or more processors 1504 (e.g., CPUs, ASICS, FPGAS, and/or the like), memory 1506, and a network interface 1508.

In this example, functions 1510 of the radio access node 1400 described herein are implemented at the one or more processing nodes 1500 or distributed across the one or more processing nodes 1500 and the control system 1402 and/or the radio unit(s) 1410 in any desired manner. In some particular embodiments, some or all of the functions 1510 of the radio access node 1400 described herein are implemented as virtual components executed by one or more virtual machines implemented in a virtual environment(s) hosted by the processing node(s) 1500. As will be appreciated by one of ordinary skill in the art, additional signaling or communication between the processing node(s) 1500 and the control system 1402 is used in order to carry out at least some of the desired functions 1510. Notably, in some embodiments, the control system 1402 may not be included, in which case the radio unit(s) 1410 communicate directly with the processing node(s) 1500 via an appropriate network interface(s).

In some embodiments, a computer program including instructions which, when executed by at least one processor, causes the at least one processor to carry out the functionality of radio access node 1400 or a node (e.g., a processing node 1500) implementing one or more of the functions 1510 of the radio access node 1400 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

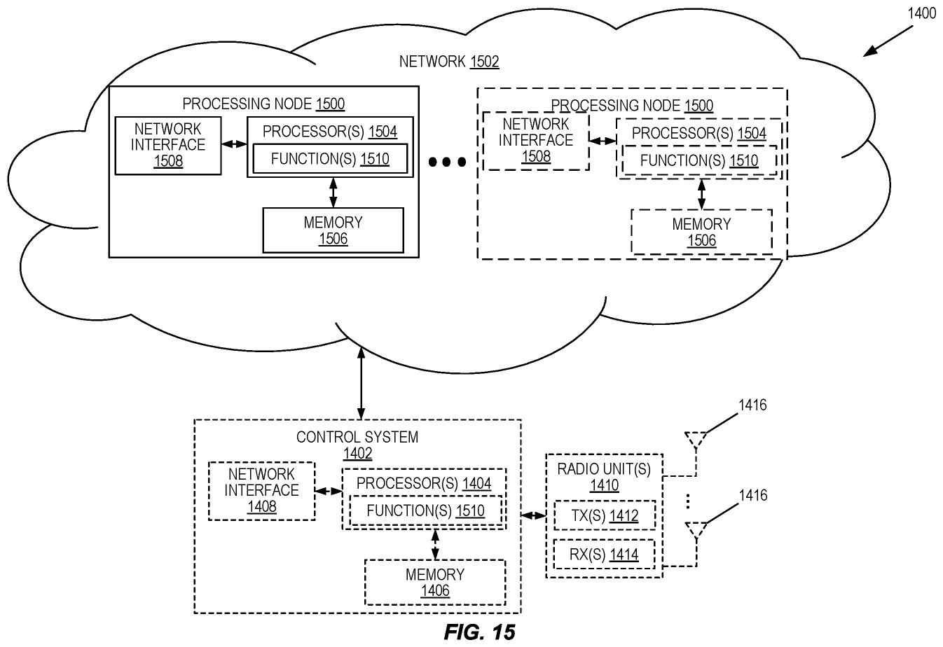

FIG. 16 is a schematic block diagram of the radio access node 1400 according to some other embodiments of the present disclosure. The radio access node 1400 includes one or more modules 1600, each of which is implemented in software. The module(s) 1600 provide the functionality of the radio access node 1400 described herein. This discussion is equally applicable to the processing node 1500 of FIG. 15 where the modules 1600 may be implemented at one of the processing nodes 1500 or distributed across multiple processing nodes 1500 and/or distributed across the processing node(s) 1500 and the control system 1402.

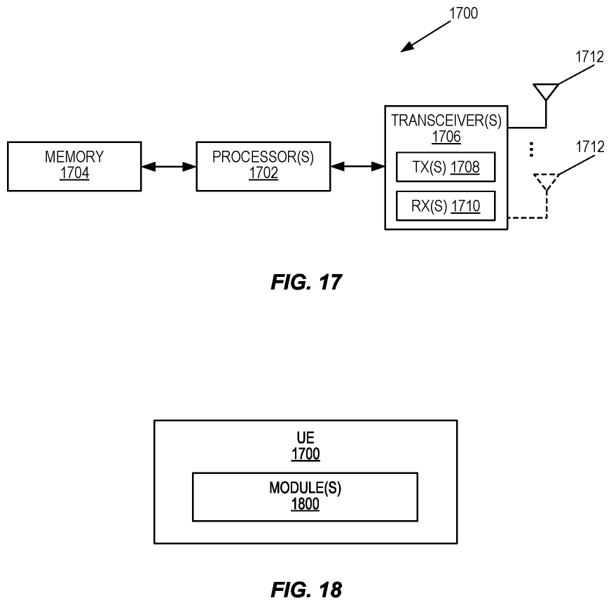

FIG. 17 is a schematic block diagram of a wireless communication device 1700 according to some embodiments of the present disclosure. As illustrated, the wireless communication device 1700 includes one or more processors 1702 (e.g., CPUs, ASICS, FPGAs, and/or the like), memory 1704, and one or more transceivers 1706 each including one or more transmitters 1708 and one or more receivers 1710 coupled to one or more antennas 1712. The transceiver(s) 1706 includes radio-front end circuitry connected to the antenna(s) 1712 that is configured to condition signals communicated between the antenna(s) 1712 and the processor(s) 1702, as will be appreciated by on of ordinary skill in the art. The processors 1702 are also referred to herein as processing circuitry. The transceivers 1706 are also referred to herein as radio circuitry. In some embodiments, the functionality of the wireless communication device 1700 described above may be fully or partially implemented in software that is, e.g., stored in the memory 1704 and executed by the processor(s) 1702. Note that the wireless communication device 1700 may include additional components not illustrated in FIG. 17 such as, e.g., one or more user interface components (e.g., an input/output interface including a display, buttons, a touch screen, a microphone, a speaker(s), and/or the like and/or any other components for allowing input of information into the wireless communication device 1700 and/or allowing output of information from the wireless communication device 1700), a power supply (e.g., a battery and associated power circuitry), etc.

In some embodiments, a computer program including instructions which, when executed by at least one processor, causes the at least one processor to carry out the functionality of the wireless communication device 1700 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 18 is a schematic block diagram of the wireless communication device 1700 according to some other embodiments of the present disclosure. The wireless communication device 1700 includes one or more modules 1800, each of which is implemented in software. The module(s) 1800 provide the functionality of the wireless communication device 1700 described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Some of the embodiments of the present disclosure include:

Embodiment 1: A method implemented in a base station (1302) for configuring uplink carrier aggregation, UL CA, for a User Equipment device, UE, (1312) comprising: providing (902) a first indication to the UE (1312) that the waveforms of one or more Physical Uplink Shared Channel, PUSCH, transmissions in one or more corresponding uplink, UL, carriers are to be switched from a Cyclic Prefix Orthogonal Frequency Division Multiplexing, CP-OFDM, waveform to a Discrete Fourier Transform Spread OFDM, DFT-S-OFDM, waveform; and providing (904) a second indication to the UE (1312) of a carrier of the one or more UL carriers in which the UE (1312) should prioritize power allocation for the corresponding PUSCH transmission.

Embodiment 2: The method of embodiment 1, wherein the second indication is either an explicit indication or an implicit indication.

Embodiment 3: The method of embodiment 1, wherein the first indication comprises the second indication.

Embodiment 4: The method of embodiment 1, wherein the second indication is separate from the first indication.

Embodiment 5: The method of any of embodiments 1-4, wherein the UL carrier in which the UE should prioritize power allocation is an UL carrier in which the base station (1302) has determined has PUSCH coverage issue.

Embodiment 6: The method of any of embodiments 1-5, wherein the providing the first indication is in response to receiving a Power Headroom Report from the UE (1312).

Embodiment 7: A method implemented in User Equipment device, UE, (1312) for implementing uplink carrier aggregation, UL CA, comprising: receiving (1002) a first indication from a base station (1302) that the waveforms of one or more Physical Uplink Shared Channel, PUSCH, transmissions in one or more corresponding uplink, UL, carriers are to be switched from a Cyclic Prefix Orthogonal Frequency Division Multiplexing, CP-OFDM, waveform to a Discrete Fourier Transform Spread OFDM, DFT-S-OFDM, waveform; receiving (1004) a second indication from the base station (1302) of a carrier of the one or more UL carriers in which the UE (1312) should prioritize power allocation for the PUSCH transmission corresponding to the carrier; and prioritizing (1006) power allocation for the carrier of the one or more UL carriers at the PUSCH transmission occasion of the PUSCH transmission or until the PUSCH transmission is complete.

Embodiment 8: The method of embodiment 7, wherein the prioritizing power allocation further comprises one or more of: initiating the PUSCH transmission in the indicated carrier with PUSCH transmission power P_{PUSCH, b,f,c}(i, j, q_{d}, l) equal to

$${P}_{O \_ P USCH , b , f , c} ( j ) + {log}_{10} ( {2}^{μ} \cdot {M}_{RB , b , f , c}^{PUSCH} ( i ) ) + {α}_{b , f , c} ( j ) \cdot {PL}_{b , f , c} ( {q}_{d} ) + {Δ}_{T F , b , f , c} ( i ) + {f}_{b , f , c} ( i , l ) ;$$

refraining from increasing (1010) an estimated pathloss for carriers other than the carrier indicated in the indication from a previous estimation; and refraining from increasing (1012) transmission powers for the carriers other than the carrier indicated in the indication due to a TPC command.

Embodiment 9: The method of embodiment 7, wherein in response to a total UE transmit power for the PUSCH transmission, a Physical Uplink Control Channel, PUCCH, transmission, a Physical Random Access Channel, PRACH, transmission, or a Sounding Reference Signal, SRS, transmission, on serving cells in a predefined frequency range in a transmission occasion exceeds a predefined maximum power and PUSCH transmissions in multiple carriers are of a same priority order, the method further comprises: prioritizing (1008) power allocation for the PUSCH transmission of the carrier of the one or more UL carriers.

Embodiment 10: A method implemented in a User Equipment device, UE, (1312) for implementing uplink carrier aggregation, UL CA, comprising: receiving (1102) an indication to provide a base station (1302) with a report of power information associated with a carrier of a serving cell of the one or more UL carriers about a Discrete Fourier Transform Spread OFDM, DFT-S-OFDM, waveform when a current waveform associated with the carrier of the serving cell is a Cyclic Prefix Orthogonal Frequency Division Multiplexing, CP-OFDM, waveform; and prioritizing (1104) power allocation for the carrier of the serving cell of the one or more UL carriers starting from when the report is transmitted until a trigger event occurs.

Embodiment 11: The method of embodiment 10, wherein the prioritizing power allocation further comprises one or more of: initiating the PUSCH transmission in the indicated carrier with PUSCH transmission power P_{PUSCH, b,f,c}(i, j, q_{d}, l) equal to

$${P}_{O \_ P USCH , b , f , c} ( j ) + {log}_{10} ( {2}^{μ} \cdot {M}_{RB , b , f , c}^{PUSCH} ( i ) ) + {α}_{b , f , c} ( j ) \cdot {PL}_{b , f , c} ( {q}_{d} ) + {Δ}_{T F , b , f , c} ( i ) + {f}_{b , f , c} ( i , l ) ;$$

refraining from increasing (1106) an estimated pathloss for carriers other than the carrier indicated in the indication from a previous estimation; and refraining from increasing (1108) transmission powers for the carriers other than the carrier indicated in the indication due to a TPC command.

Embodiment 12: The method of any of embodiments 10-11, wherein the triggering event is one or more of: a predetermined Radio Resource Control, RRC, or Downlink Control Information, DCI, timer; reception of an indication to perform waveform switching or to prioritize power allocation for a PUSCH transmission in a different carrier; and a subsequent Physical Downlink Control Channel monitoring occasion that indicates a potential waveform switching.

Embodiment 13: A method implemented in User Equipment device, UE, (1312) for implementing uplink carrier aggregation, UL CA, comprising: providing (1202) a first power headroom report, PHR, to a base station (1302) indicating a first power headroom available to the UE (1312); modifying (1204) a power allocation across one or more UL carriers; and providing (1206) a second PHR to the base station (1302) indicating a second power headroom in response to the power allocation modification. \

Embodiment 14: A base station (1302) configured to communicate with a User Equipment (UE), (1312) the base station (1302) comprising a radio interface and processing circuitry configured to perform any of the methods in embodiments 1-6.

Embodiment 15: A User Equipment, UE, (1312) configured to communicate with a base station (1302), the UE (1312) comprising a radio interface and processing circuitry configured to perform any of the methods in embodiments 7-13.

Those skilled in the art will recognize improvements and modifications to the embodiments of the present disclosure. All such improvements and modifications are considered within the scope of the concepts disclosed herein.

1. A method implemented in a base station for configuring uplink carrier aggregation, UL CA, for a User Equipment device (UE) comprising:
providing a first indication to the UE that the waveforms of one or more Physical Uplink Shared Channel (PUSCH) transmissions in one or more corresponding uplink (UL) carriers are to be switched from a Cyclic Prefix Orthogonal Frequency Division Multiplexing (CP-OFDM) waveform to a Discrete Fourier Transform Spread OFDM (DFT-S-OFDM) waveform; and
providing a second indication to the UE of a PUSCH transmission in a carrier of the one or more UL carriers in which the UE should prioritize power allocation.

2. The method of claim 1, wherein the second indication is either an explicit indication or an implicit indication.

3. The method of claim 1, wherein the first indication comprises the second indication.

4. The method of claim 1, wherein the second indication is implicit based on the first indication.

5. The method of claim 1, wherein the PUSCH transmission in the UL carrier in which the UE should prioritize power allocation is in a UL carrier in which the PUSCH transmission is switched from the CP-OFDM waveform to the DFT-S-OFDM waveform.

6. The method of claim 5, wherein the UL carrier is an only UL carrier in which the waveform of the PUSCH transmission is switched from the CP-OFDM waveform to the DFT-S-OFDM waveform of the UL carriers.

7. The method of claim 1, wherein the first indication and the second indication are provided to the UE via downlink control information.

8. The method of claim 1, wherein the providing the first indication is in response to receiving a Power Headroom Report from the UE.

9. A base station configured to communicate with a User Equipment (UE) the base station configured to perform uplink carrier aggregation (UL CA) for the UE, wherein the base station comprises a radio interface and processing circuitry configured to cause the base station to:
provide a first indication to the UE that the waveforms of one or more Physical Uplink Shared Channel (PUSCH) transmissions in one or more corresponding uplink (UL) carriers are to be switched from a Cyclic Prefix Orthogonal Frequency Division Multiplexing (CP OFDM) waveform to a Discrete Fourier Transform Spread OFDM (DFT-S-OFDM) waveform; and
provide a second indication to the UE of a PUSCH transmission in a carrier of the one or more UL carriers in which the UE should prioritize power allocation.

10. (canceled)

11. A method implemented in a User Equipment device (UE) for implementing uplink carrier aggregation (UL CA) comprising:
receiving a first indication from a base station that waveforms of one or more Physical Uplink Shared Channel (PUSCH) transmissions in one or more corresponding uplink (UL) carriers are to be switched from a Cyclic Prefix Orthogonal Frequency Division Multiplexing, (CP-OFDM) waveform to a Discrete Fourier Transform Spread OFDM (DFT-S-OFDM) waveform;
receiving a second indication from the base station of a PUSCH transmission in a UL carrier of the one or more UL carriers in which the UE should prioritize power allocation.

12. The method of claim 11, further comprising:
prioritizing power allocation for the PUSCH transmission in the UL carrier of the one or more UL carriers at the PUSCH transmission occasion of the PUSCH transmission or until the PUSCH transmission is complete.

13. The method of claim 11, wherein the second indication is either an explicit indication or an implicit indication.

14. The method of claim 11, wherein the first indication comprises the second indication.

15. The method of claim 11, wherein the second indication is implicit based on the first indication.

16. The method of claim 12, wherein the PUSCH transmission in the UL carrier in which the UE prioritizes power allocation is in the UL carrier in which a waveform of the PUSCH transmission is switched from the CP-OFDM waveform to the DFT-S-OFDM waveform.

17. The method of claim 16, wherein the UL carrier is an only UL carrier switched from the CP-OFDM waveform to the DFT-S-OFDM waveform of the UL carriers.

18. The method of claim 11, wherein the first indication and the second indication are received via downlink control information.

19. The method of claim 11, wherein the receiving the first indication is in response to providing a Power Headroom Report to the base station.

20. A User Equipment (UE) device configured to for implementing uplink carrier aggregation (UL CA) wherein the UE comprises a radio interface and processing circuitry configured to cause the UE to:
receive a first indication from a base station that the waveforms of one or more Physical Uplink Shared Channel (PUSCH) transmissions in one or more corresponding uplink (UL) carriers are to be switched from a Cyclic Prefix Orthogonal Frequency Division Multiplexing (CP OFDM) waveform to a Discrete Fourier Transform Spread OFDM (DFT-S-OFDM) waveform;
receive a second indication from the base station of a UL carrier of the one or more UL carriers in which the UE should prioritize power allocation for the PUSCH transmission corresponding to the carrier.

21. (canceled)
